(19) United States
(12) Patent Application Publication
(10) Pub. No.: US 2026/0298830 A1
(43) Pub. Date: Oct. 1, 2026

(54) DEVICES AND METHODS FOR THE PRECISE MANIPULATION OF ANISOTROPIC PARTICLES

(71) Applicant: BOARD OF REGENTS, THE UNIVERSITY OF TEXAS SYSTEM, Austin, TX (US)

(72) Inventors: Donglei FAN, Austin, TX (US); Huaizhi LI, Austin, TX (US); Daniel TEAL, Berkeley, CA (US); Zexi LIANG, Ithaca, NY (US)

(21) Appl. No.: 19/479,060

(22) PCT Filed: Apr. 25, 2024
(86) PCT No.: PCT/US2024/026294

§ 371 Date: Oct. 27, 2025

Related U.S. Application Data
(60) Provisional application No. 63/498,247, filed on Apr. 25, 2023.

(51) Int. Cl. G01N 21/65; G01N 21/25

(52) U.S. Cl. CPC G01N 21/658; G01N 21/25; G01N 2021/258; G01N 2800/00

(57) ABSTRACT

The present disclosure provides devices, systems, and methods for controllably moving and orienting an anisotropic particle in a suspension with ultrahigh precision.

### CROSS-REFERENCE TO RELATED APPLICATIONS

This application claims the benefit of priority to U.S. Provisional Application No. 63/498,247 filed Apr. 25, 2023, which is hereby incorporated herein by reference in its entirety.

### STATEMENT OF GOVERNMENT SUPPORT

This invention was made with government support under Grant Nos. ECCS1710922 and ECCS1930649, awarded by the National Science Foundation. The government has certain rights in the invention.

### BACKGROUND

The ability to position and orient nanoparticles is useful in a number of different applications, including diagnostics, fabrication of nanostructures, therapeutic delivery, and chemical analysis using spectral sensing. However, precise control of nanoparticles suspended in a medium in both position and orientation has not been realized due to the difficult random effects of Brownian motion imposed on the particle. Moreover, of the limited available schemes that can manipulate untethered probes, such systems are largely restricted to two-dimensions (2D) and cannot be used to freely orient an untethered micro/nanoprobe. Furthermore, the diffusivity of particles undergoing Brownian motion is inversely proportional to the particle's size, which limits the degree of control as smaller particles are used. Thus, applications involving diagnostics, nanofabrication, therapeutic delivery, and chemical analysis would benefit from increased resolution and control over individual nanoparticles.

### SUMMARY

In accordance with the purposes of the disclosed systems, devices, and methods, as embodied and broadly described herein, the disclosed subject matter relates to the precise manipulation of anisotropic particles via electrokinetic effects.

In some examples, disclosed herein are devices comprising: a chamber defining a volume for containing a suspension comprising an anisotropic particle; four co-planar electrodes disposed on an XY plane, wherein the four co-planar electrodes comprise a first pair of opposed and spaced apart electrodes, and a second pair of opposed and spaced apart electrodes orthogonally positioned relative to the first pair electrodes; and a third pair of opposed and spaced apart upper and lower electrodes, wherein the third pair of electrodes form a space therebetween comprising the four co-planar electrodes and anisotropic particle; wherein, in use, the anisotropic particle is electromagnetically coupled to each of the four co-planar electrodes and upper and lower electrodes.

In some examples, the first pair of electrodes is configured to controllably apply a voltage in an x-direction and the second pair of electrodes is configured to controllably apply a voltage in a y-direction. In some examples, the third pair of electrodes is configured to controllably apply a voltage in a z-direction.

In some examples, the first, second, and/or third pair of electrodes are configured to controllably apply both a DC voltage and an AC voltage.

In some examples, the first, second, and/or third pair of electrodes are disposed within the chamber.

In some examples, the first pair of electrodes and second pair of electrodes are separated by the same distance. In some examples, the first pair and/or second pair of electrodes are separated by a distance of from 30 μm to 10 mm.

In some examples, the upper and/or lower electrodes comprise an optically transparent material. In some examples, the optically transparent material comprises indium tin oxide (ITO) or fluorine doped tin oxide (FTO) (e.g., an indium tin oxide (ITO) or fluorine doped tin oxide (FTO) thin film).

In some examples, the four co-planar electrodes include non-reactive electrodes (e.g., gold and/or platinum).

In some examples, the anisotropic particle comprises an anisotropic nanoparticle. In some examples, the anisotropic particle comprises a geometrically anisotropic particle. In some examples, the geometrically anisotropic particle comprises a rod-shaped particle (e.g., a nanowire). In some examples, the anisotropic particle is operatively linked to a moiety. In some examples, the moiety comprises a small molecule, a protein, a peptide, DNA, RNA, a nucleic acid, a cell, a tissue, a virus, a nanoparticle, a metabolite, or a combination or derivative thereof. In some examples, the moiety comprises a fluorophore. In some examples, the anisotropic particle is operatively coupled to a nanosensor. In some examples, the anisotropic particle comprises a gold tip.

In some examples, the anisotropic particle comprises a nanopatterned surface. In some examples, the nanopatterned surface comprises plasmonic nanoparticles. In some examples, the plasmonic nanoparticles comprise silver plasmonic nanoparticles.

In some examples, the device further includes a plurality of anisotropic particles.

In some examples, the chamber comprises an insulating polymer. In some examples, the insulating polymer comprises polydimethylsiloxane (PDMS).

In some examples, the suspension comprises a dielectric liquid (e.g., deionized water). In some examples, the suspension comprises a biocompatible liquid.

Also described herein are systems including: an imaging element positioned to interrogate a location and orientation of the anisotropic particle within the device as described herein; a processor operatively connected to the imaging element and a power source electrically coupled to supply a power output to each of the first, second, and third pairs of electrodes, wherein the processor is configured to: obtain a signal from the imaging element indicating a current position and orientation (e.g., current location and/or current orientation) of the anisotropic particle relative to a target position and orientation (e.g., target location and/or target orientation); determine a corrective voltage to apply to each of the first, second, and third pairs of electrodes from the signal and the target position; and control the power source to modulate the power output to each of the first, second, and third pairs of electrodes to the corrective voltage.

In some examples, the processor is configured to receive user-generated instructions (e.g., the target location and/or the target orientation).

In some examples, the imaging element comprises a microscope, such as a scanning electron microscope (SEM).

In some examples, the system further includes a light emitting device (e.g., a laser).

In some examples, the power source includes a battery.

Additionally disclosed herein are methods for controlling a position and/or 3D orientation of an anisotropic particle in real time. In some examples, the methods include: determining positional information of an anisotropic particle within the device disclosed above using an imaging element; and adjusting a voltage in each of the first, second, and third pairs of electrodes of the device based on the positional information of the anisotropic particle in order to induce or suppress motion of the anisotropic particle.

In some examples, disclosed herein are methods for scanning a surface. The methods can include: suppressing Brownian motion of the anisotropic particle by determining positional information of an anisotropic particle within the device disclosed above using an imaging element; and adjusting a voltage in each of the first, second, and third pairs of electrodes of the device based on the positional information of the anisotropic particle in order to suppress motion of the anisotropic particle; concurrently recording positional information of the anisotropic particle and a first feedback signal (e.g., voltage or current) for a first pixel of the surface; moving the anisotropic particle relative to the surface to a second pixel; and concurrently recording positional information of the anisotropic particle and a second feedback signal for the second pixel of the surface. In some examples, the method further includes forming a topological representation of the surface from the first feedback signal and second feedback signal. In some examples, the first feedback signal and/or second feedback signal comprises a mean current and/or a mean voltage over a recording time window (e.g., about 1 second).

In various examples according to the present disclosure are methods for diagnosing a condition in a subject. These methods can include, for example, contacting an anisotropic particle with a biological sample obtained from the subject; determining positional and angular information of the anisotropic particle within the devices disclosed herewith using an imaging element; adjusting a voltage in each of the first, second, and third pairs of electrodes of the device based on the positional information of the anisotropic particle in order to induce or suppress motion of the anisotropic particle; and determining, based on one or more detected properties, a diagnosis for the condition.

Also described herein are methods for detecting the presence of an analyte. Various embodiments include: determining, using an imaging element, positional information of an anisotropic particle comprising a nanopatterned surface within one of the devices described above; adjusting a voltage in each of the first, second, and third pairs of electrodes of the device based on the positional information of the anisotropic particle to move the anisotropic particle to a target position within the device; irradiating the anisotropic particle with a source of radiation to produce a surface enhanced Raman spectroscopy (SERS) signal; determining, based on the SERS signal, whether an analyte is present at the target position.

A number of embodiments of the disclosure have been described. Nevertheless, it will be understood that various modifications may be made without departing from the spirit and scope of the invention. Accordingly, other embodiments are within the scope of the following claims.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

### BRIEF DESCRIPTION OF THE DRAWINGS

The skilled person in the art will understand that the drawings described below are for illustration purposes only.

FIG. 1A shows an example system for the precise manipulation of an anisotropic particle for performing surface-enhanced Raman scattering (SERS) according to one aspect of the present disclosure.

FIG. 1B shows an expanded view of the device used in the system of FIG. 1A.

FIG. 2 shows an example of a circuit design of the function generator with four outputs. DAC (Digital-Analog Converters) convert computer program-generated digital electric signals into analog electric voltages that are further amplified, filtered, and inverted, providing four output electric voltages for manipulation in both X and Y directions.

FIG. 3 shows a representation of the electrophoresis/electroosmosis, electro-orientation, and electro-rotation of the four co-planar electrodes of the present device.

FIG. 4 shows the principles of electrophoresis/electroosmosis (left) and the application of voltages in the z-direction. Because the configuration is asymmetric, the electric potential on the XY-plane, V_{c} is set to zero so that there is no potential difference between the center and the surroundings. The voltages Vₐ and V_{b} can be determined by applying the AC voltage divider law on the equivalent circuit. As a result, the particles stay at the center and are all aligned vertically.

FIG. 5 shows an arrangement of a plurality of surface-modified anisotropic particles that have been controllably moved and fixed to a location on a substrate via UV light.

FIG. 6A shows a block diagram of a proportional-integral controller for maintaining a position and/or orientation of an anisotropic particle by manipulating a corresponding voltage towards a set point.

FIG. 6B shows example voltage signals for different control modes.

FIG. 7 shows (Panel a) 2D displacement and (Panel b) time-dependent positional mean-square-displacement (MSD) of nanowires in deionized water. Brownian motion and under proportional-integral (PI) control. Inset in (Panel b): histogram of displacement under PI control with a Gaussian fit. (Panel c) PI-control performance (top): position versus time of a nanowire moving to a new set-point. The nanowire is trapped at the exact target position in comparison to that of the P control (bottom) (160 FPS, P control, Kₚ=0.077; PI control, Kₚ=0.06, Kᵢ=1.66). (Panel d) precision in the position of aligned nanowires of various lengths along their long (σₐ) and short axes (σ_{b}), and non-aligned (σ_{free}). Alignment of nanowires is achieved via electrorotation proportional (P) control. The 0.8 μm nanowire is orientated via a linear 50 Vₚₚ, 500 kHz AC E-field. The horizontal and vertical error bars represent the standard deviations of the length and precision measured from 5 to 6 different nanowires. (Panel e) Precision of position control of Au nanowires (4 μm in length, multiple wires) along x (σₓ) and y axis (σ_{y}), aligned at a series of angles (error bars in FIG. 13), systematically confirm the enhanced manipulation precision along the short axis of a longitudinal nanostructure. Dashed lines in (Panels d-e) are to guide the eye.

FIG. 8 shows (Panel a) Snapshots of a nanowire aligned at azimuth and altitude angles of 0 to 135° and 0 to 90°, respectively. (Panel b) Angular MSD of nanowires due to Brownian motion, under alignment, and with rotational PI control versus time. Inset: histogram of angle distribution under rotational PI control fitted with a Gaussian distribution. (Panel c) The rotational diffusivity of Au nanowires versus length agrees well with the theoretical prediction (solid line) based on the Broersma relation. (Panel d) Precision of the angular manipulation under alignment and rotation PI control versus length. Angle control of 0.8 μm nanowires is achieved with a simple linear AC E-field at 50Vₚₚ. (Panel e) Directly aligning a nanowire with a linear AC E-field requires a much higher voltage compared to rotation and alignment PI controls to achieve the same orientation precision (nanowires: 4 μm in length and 170 nm in diameter). Dashed lines in (Panels d-f) are a guide to the eye. (Panel f) Altitude angle versus voltage in the Z-direction at 10 Vₚₚ and 0 Vₚₚ in the X-direction. Fit agrees with experimental studies. Insets: top-down microscope image of nanowires. (Panels g-i) Characterizing and optimizing manipulation precision. Manipulation precision increases with (Panel g) video capture rate (160 FPS and 850 FPS). (Panel h) Surface-charge treatment effect: low impact to angular precision; enhanced precision in positioning due to increased propelling force via optimizing surface charging. (Panel i) Manipulation precision increases with viscosity of the medium (glycerol-water mixture) for both positioning and angular control along in-plane long axis, in-plane short axis, and vertical orientations. The vertical error bars in (Panels d-i) represent the standard deviations of the precision measured for multiple different nanowires. The horizontal error bars in (Panel d) and (Panel e) represent the standard deviations of lengths and voltages measured for multiple nanowires, respectively.

FIG. 9 shows (Panel a) A nanowire ‘writes’ the image while translating, rotating, and aligning under full computer control. (Panel b) SEM image and schematic of a nanopen with a 50-nm Au tip and integrated magnetic Ni. (Panel c) Angular precision versus velocity (single wire). Average of measurements controlled at 0°, 45°, and 90°, each angle for 6 times; when a wire's long axis is tangent to the trajectory, the angle is defined as 0°. The linear trajectory has a total length of 116-μm. (Panel d) Manipulation accuracy versus velocity of the propelled vertically oriented nanopen in (Panel b). Error bar represents the standard deviation of position accuracy for a given speed. (Panel e) Writing “Nanopen” at 2.7 to 35.6 μm/s, sampling interval is 1/30 seconds. (Panels f-g) Overlaps of targeted and actual positions versus time at (Panel f) 2.67 and (Panel g) 35.6 μm/s.

FIG. 10 shows a series of snapshots of nanowires aligned at different altitude and azimuth angles. A titled nanowire traces a star pattern and is assembled on the substrate upon UV illumination while maintaining its 3D angle.

FIG. 11 shows (Panel a) SEM image and (Panel b) schematic of a vertically aligned silica-encapsulated nanowire with high-density plasmonic Ag nanoparticles on the surface for detecting Raman signals from a single bacterial cell via direct tip contact. (Panel c) Raman spectra obtained at 20 μm in distance, in-contact, and 15 μm in distance from an E. coli cell after contacting. Insets: optical images of the positions of the nanocapsule sensor relative to E. coli.

FIG. 12 shows (Panel a) Diffusion coefficients of nanowires (170 nm in diameter, ~2-7 μm in lengths) in deionized water along the orthogonal a, b and x, y directions in the body and lab frames, respectively, in (Panel b). Theoretical fit (solid lines) with the Broersma relation, which agree well with experiments; the correction factors (ξ) are 0.883 and 0.801 for translational diffusivities along the long (Dₐ) and short axis (D_{b}), respectively.

FIG. 13 shows translocation manipulation precision of Au nanowires (4-μm in length) along x (σₓ) and y axis (σ_{y}), aligned at different angles with a rotational P control (with error bars).

FIG. 14 illustrates that precise particle manipulation can be realized, as illustrated by both in-plane tracing and vertical drawing of cat.

FIG. 15 shows the manipulation of nanowires in cell culture solution. Snapshots of a 10-μm Au@SiO₂ nanowire manipulated around a live mouse endothelial cell (CRL-2299, ATCC) in cell buffer. The cell buffer consists of 0.3 M sucrose, 1 vol % Fetal Bovine Serum (FBS), and 20 mM HEPES (4-(2-hydroxyethyl)-1-piperazineethanesulfonic acid) to maintain suitable pH and osmotic pressure for cells.

FIG. 16 shows a top view (Panel a), side view (Panel b) and SEM image (Panel c) of a substrate patterned by photolithography used for testing scanning applications (Substrate: S1811, thickness=1.1 um, width=15 um, gap=25 um).

FIG. 17 shows an image of the 1.5 μm Au nanospheres used according to one example.

FIGS. 18A-18C each show plots depicting the electrokinetic effects observed at various positions along the substrate.

FIG. 19 shows electrokinetic effects observed when scanning an E. coli cell dried on a substrate.

FIG. 20 shows mean current and voltages observed when scanning an E. coli cell dried on a substrate.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

In this specification and in the claims that follow, reference will be made to a number of terms, which shall be defined to have the following meanings.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a compound”, “a composition”, or “a disorder”, includes, but is not limited to, one or more such compounds, compositions, or disorders, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

One skilled in the art will readily appreciate that the present invention is well adapted to carry out the objects and obtain the ends and advantages mentioned, as well as those inherent therein. The devices, device elements, methods, and materials described herein as presently representative of preferred embodiments are exemplary and are not intended as limitations on the scope of the invention. Changes therein and other uses will occur to those skilled in the art and are intended to be encompassed within this invention.

### Devices and Systems

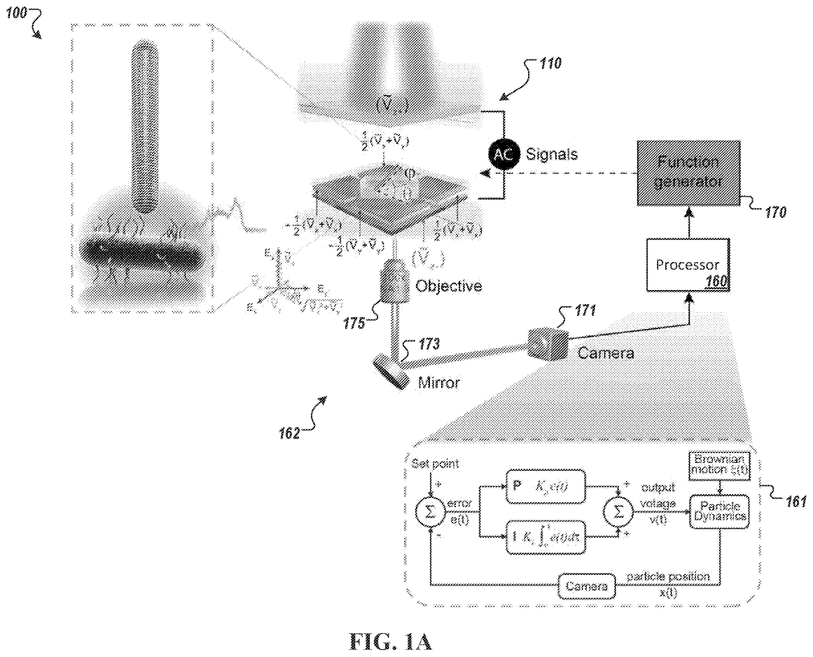

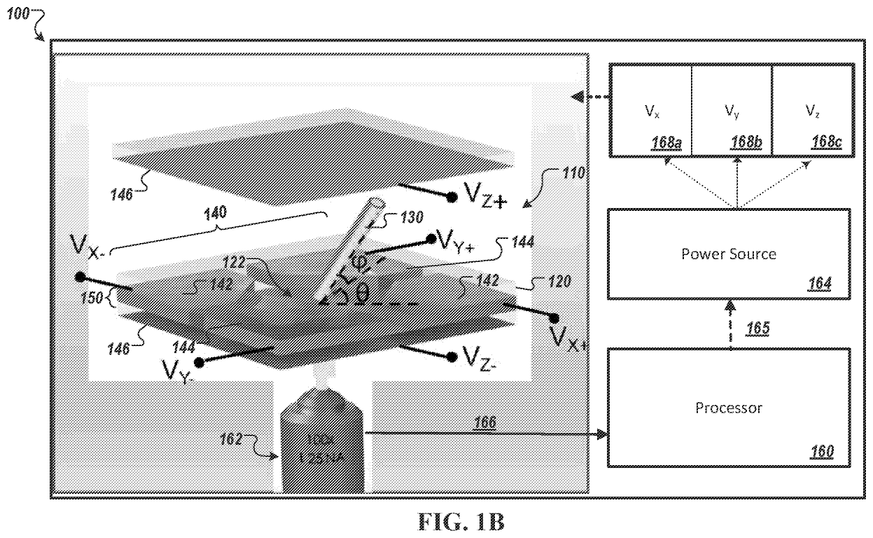

FIGS. 1A-1B show an example system 100 for the precise manipulation of anisotropic particle for performing surface-enhanced Raman scattering (SERS) according to one aspect of the present disclosure.

Referring specifically to FIG. 1B, an expanded view of the device 110 of FIG. 1A is shown. The device 110 has a chamber 120 defining a volume 122 that contains a suspension comprising an anisotropic particle 130 (enlarged for clarity). The device 110 also includes four co-planar electrodes 140 disposed on an XY plane. The four co-planar electrodes 140 include a first pair of opposed and spaced apart electrodes 142, and a second pair of opposed and spaced apart electrodes 144 orthogonally positioned relative to the first pair of electrodes 142. Although the device 110 of FIGS. 1A-1B includes four co-planar electrodes 140, other devices can utilize additional electrode components arranged to provide the requisite electrokinetic effects. The device 110 further has a third pair of opposed and spaced apart upper and lower electrodes 146 (the upper electrode shown separate from the chamber 120 of the device 110). The third pair of electrodes 146 form a space 150 therebetween comprising the four co-planar electrodes 140 and anisotropic particle 130. In use, the anisotropic particle 130 is electromagnetically coupled to each of the four co-planar electrodes 140 and upper and lower electrodes 146. The term “electromagnetically coupled” as used herein, means the generation of voltages, electric currents, and magnetic fields by the electrodes induces an electrokinetic effect in the anisotropic particle.

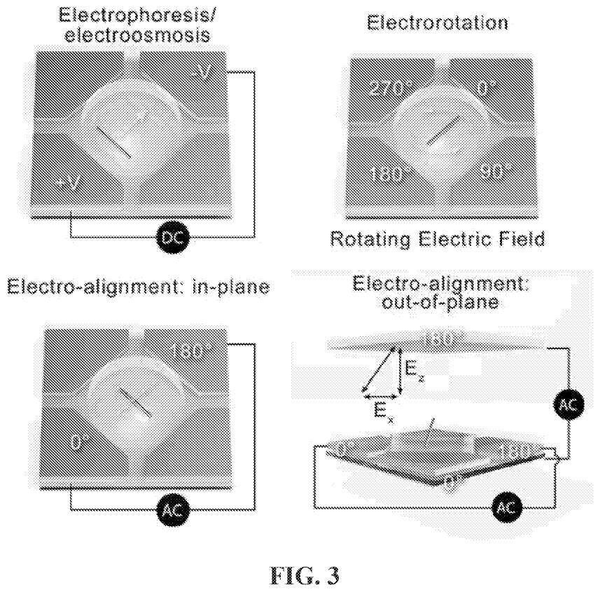

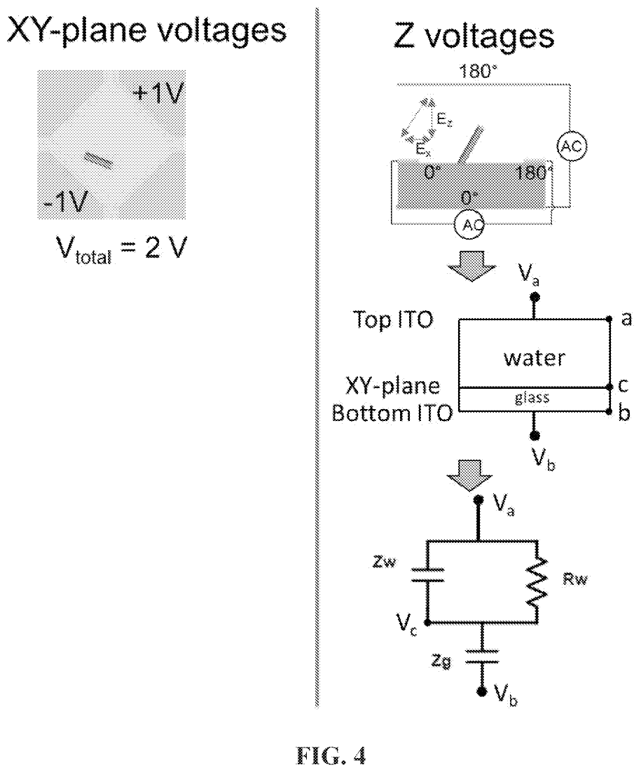

The first pair of electrodes 142 can be configured to controllably apply a voltage in an x-direction while the second pair 144 of electrodes is configured to controllably apply a voltage in a y-direction. The third pair of electrodes 146 is configured to controllably apply a voltage in a z-direction. In some examples, the first, second, and/or third pair of electrodes are configured to controllably apply both a DC voltage and an AC voltage. Applying a DC voltage can cause the anisotropic particle to be translated due to electrophoresis or electroosmosis. When an AC voltage is applied, the anisotropic particle can be aligned along the direction of the electric field due to dipole-E-field interaction. A circularly polarized AC E-field can be used to rotate the anisotropic particle. A representation of these techniques is shown in FIGS. 3 and 4. The coordination between the respective pairs of electrodes via a superimposition of DC and AC voltages advantageously allows for the simultaneous control of both position in 2-D and orientation in 3-D.

In some examples, the first, second, and/or third pair of electrodes are disposed within the chamber. In some examples, the first pair and/or the second pair of electrodes are separated by a distance of from 30 μm to 10 mm (e.g., from 30 μm to 5 mm, from 30 μm to 4 mm, from 30 μm to 3 mm, from 30 μm to 2 mm, from 30 μm to 1 mm, from 30 μm to 5 mm, from 30 μm to 500 μm, from 30 μm to 400 μm, from 30 μm to 300 μm, from 30 μm to 200 μm, from 30 μm to 100 μm, from 30 μm to 50 μm, from 50 μm to 10 mm, from 100 μm to 10 mm, from 200 μm to 10 mm, from 300 μm to 10 mm, from 400 μm to 10 mm, from 500 μm to 10 mm, from 1 mm to 10 mm).

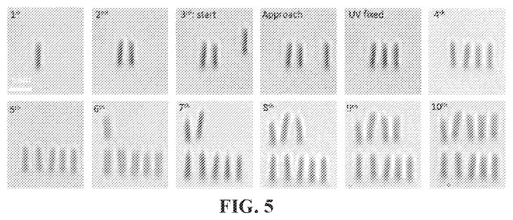

In some examples, the chamber comprises an insulating polymer. Non-limiting examples of insulating polymers suitable for the present device include silicones, siloxanes, polydimethylsiloxane (PDMS), rubber materials, latex materials, polyesters, polypropylenes, polytetrafluoroethylenes (PTFE), parylenes, liquid crystal polymers, polyimides, polyesteramides, polyamides, polybutyldienes (PBD), copolymers thereof, and blends thereof. In some examples, the insulating polymer includes polydimethylsiloxane (PDMS). In some examples, the device further includes a plurality of anisotropic particles such as those shown in FIG. 5. In some embodiments, the suspension comprises a dielectric liquid (e.g., deionized water). In some examples, the suspension comprises a biocompatible liquid.

In some examples, the upper and/or lower electrodes comprise an optically transparent material. Some non-limiting examples of optically transparent materials suitable for the present electrodes include those comprising indium tin oxide (ITO) or fluorine doped tin oxide (FTO) thin films. In various examples, the upper and/or lower electrodes comprise indium tin oxide (ITO). In some examples, the upper and/or lower electrodes fluorine comprise doped tin oxide (FTO) thin films. Methods for fabricating optically transparent electrodes including ITO and FTO are well known in the art. In various examples, the four co-planar electrodes each comprise non-reactive electrodes. As used herein, the term “non-reactive electrodes” refers to an electrode that is resistant to chemical change (e.g., oxidation). Examples of non-reactive electrodes include metal electrodes such as gold, platinum, palladium and the like.

The system and device described herein can be used to precisely manipulate the position of an anisotropic particle. As used herein the term “anisotropic” means having at least one property that differs in value when measured in at least one different direction. In some examples, the anisotropic particle comprises a geometrically anisotropic particle. The term “geometrically anisotropic” refers to particles that exhibit anisotropic properties as a result of their shape. In some examples, the geometrically anisotropic particle comprises a rod-shaped particle (e.g., a nanowire). In some examples, the particle can be electromagnetically anisotropic by way of using two or more (e.g., 2, 3, 4, 5, 6, 7, 8, 9, 10, etc.) different materials, such as Janus particles. Examples of synthesis techniques of Janus particles is provided by Walther et al., 2013, which is hereby incorporated by reference in its entirety. In some examples, the anisotropic particle comprises an anisotropic nanoparticle. The terms “nanostructure” and “nanoparticle” are used interchangeably and refer to a particle having at least one cross-sectional dimension that is from 1 nm to 1000 nm, such as from 100 nm to 1000 nm, or from 50 nm to 750 nm, from 50 nm to 500 nm, from 50 nm to 250 nm from 50 nm to 200 nm, or from 100 nm to 200 nm. In various embodiments, the anisotropic nanoparticle can form a nanowire having a diameter of from 1 nm to 1000 nm (e.g., from 100 nm to 1000 nm, from 50 nm to 750 nm, from 50 nm to 500 nm, from 50 nm to 250 nm from 50 nm to 200 nm, or from 100 nm to 200 nm) and a length of from 1 nm to 1000 nm (e.g., from 100 nm to 1000 nm, from 200 nm to 1000 nm, from 200 nm to 750 nm, from 250 nm to 500 nm from 250 nm to 400 nm, or from 250 nm to 350 nm). A nanostructure or nanoparticle can have any of a wide variety of shapes, and can be formed of a wide variety of materials. Examples of nanoparticles include nanorods, nanowires, nanofibers, nanotubes, nanospheres, and nanowhiskers.

In some examples, the anisotropic particle is operatively coupled to a moiety. The linkage between the moiety to the anisotropic particle can be accomplished using a number of techniques. A variety of linker moieties are generally well known in the art and can be found by one of ordinary skill in the art, for example in Bioconjugate Techniques (Academic Press, New York, 1996 or later versions) the content of which is herein incorporated by reference in its entirety for all purposes. In some examples, the moiety comprises a small molecule, a protein, a peptide, DNA, RNA, a nucleic acid, a cell, a tissue, a virus, a nanoparticle, a metabolite, or a combination or derivative thereof. These moieties can be useful for a number of different applications, such as the precise delivery of a therapeutic agent.

In various examples, the anisotropic particle is operatively coupled to a nanosensor. The term “nanosensor” refers to a nanoscale-based device that measures a physical quality and produces a signal that can be detected and analyzed. Suitable non-limiting examples of nanosensors suitable for use in the devices, systems, and methods as described herein include copper and copper oxide nanowires, porous films as well as nanoflowers and nanorods, nanostructured copper oxide/copper oxalate, nanoparticles composed of silver, gold, nickel, and nickel/palladium, such as gold nanowires, nickel hydroxide nanocomposites, boron-doped diamond nanorods, platinum/lead nanoporous networks, palladium nanoparticles, polymeric nanoparticles, and fluorescent polymeric nanosensors.

In certain embodiments, the anisotropic particle can be operatively coupled to an optically active moiety, such as a fluorophore. The term “fluorophore” refers to a compound, a portion of a compound or a composition that exhibits fluorescence. Numerous fluorophore compounds and compositions are known to those skilled in the art and include, but are not limited to benzofurans, quinolines, quinazolines, quinazolinones, indoles, benzazoles, indodicarbocyanines, borapolyazaindacenes and xanthenes, as well as other fluorophores described in Haugland, Molecular Probes, Inc. Handbook of Fluorescent Probes and Research Chemicals, (9^{th} ed., including the CD-ROM, September 2002).

In some examples, the anisotropic particle includes a metal tip configured to interact with a light source, such as a gold tip. The metal tip can interact with a source of radiation to thermally engrave or manipulate a surface. The anisotropic particle with the metal tip can be controllably moved while a light source irradiated the metal tip to etch a surface in a particular pattern. Various examples additionally include an anisotropic particle comprising a nanopatterned surface. For example, the nanopatterned surface can include plasmonic nanoparticles. As used herein, the term “plasmonic nanoparticles” refers to metal particles (e.g., gold (Au), silver (Ag), platinum (Pt), palladium (Pd), ruthenium (Ru), rhodium (Rh), osmium (Os), iridium (Ir), aluminum (Al), alloys thereof, etc.), plasmonic semiconductors (e.g., silicon carbide), doped semiconductors (e.g., aluminum-doped zinc oxide), transparent conducting oxides, perovskites, metal nitrides, silicides, germanides, and two-dimensional plasmonic materials (e.g., graphene), and combinations thereof, with electron density that can couple with electromagnetic radiation of wavelengths that are larger than the particle due to the nature of the dielectric-metal interface between the medium and the particle. Plasmonic nanoparticles typically exhibit very strong absorption and scattering spectra that are tunable by altering the shape, the composition, or the medium around their nanoparticle surface. Thus, plasmonic nanoparticles disposed on the surface of the anisotropic particle can be beneficial for a number of analytical measurement techniques including, for example, surface-enhanced Raman scattering (SERS).

As depicted in FIGS. 1A and 1B, in some examples, the system 100 can further include a processor 160 operatively connected to an imaging element 162 and a power source 164 electrically coupled to supply a respective power output 168 (168a, 168b, 168c) to each of the first 142, second 144, and third pairs 146 of electrodes. The example imaging element 162 shown in FIG. 1A includes a camera 171, a 100× objective lens 175, and a mirror 173. In this example, optical light passes through the device 110 where it is collected and magnified by the objective lens 175 before being directed to the camera 171 by the mirror 173. The processor 160 implements a feedback algorithm 161 to control a function generator 170 to provides electric voltages via the various electrodes of the device 110.

The imaging element 162 is positioned such that it can interrogate a location of the anisotropic particle 130 within the volume 122 of the device 110. When the system 100 is being used, the processor 160 is configured to obtain a signal 166 from the imaging element 162 indicating a current position (e.g., current location and/or current orientation) of the anisotropic particle 130 relative to a target position (e.g., target location and/or target orientation). The processor 160 then determines a corrective voltage 165 (165a, 165b, 165c) to apply to each of the first 142, second 144, and third pairs 146 of electrodes from the signal 166 and the target position. The processor 160 then controls the power source 164 to modulate the respective power output 168 (168a, 168b, 168c) to each of the first 142, second 144, and third pairs 146 of electrodes to exhibit the corrective voltage 165.

The processor 160 of the described system, for processing information associated with the process(es) or method(s) described herein, may be, for example, any computer processor is known in the art capable of performing calculations and directing functions for interpreting and/or performing input, output, calculation, and display of data in accordance with the disclosed methods. The processor may comprise any type of processing unit, such as typical computer processor(s), controller(s), microcontroller(s), microprocessor s), and/or programmable logic controllers (PLCs). The information to be processed by the processor may include, for example, information contained in analog or digital signals and/or translated signals and/or information contained in a data storage. Processing of the information may involve, for example, performing calculations on received signals such as, but not limited to, vector analysis, picture identification, pattern recognition, frequency analysis/Fourier transforms, numerical computations, machine learning, or, as described herein, applying predetermined or recursively fit correlative algorithms to received sensor data. In some embodiments, the system comprises more than one processor, and the reference herein to “processor” includes reference to multiple processors and vice versa. In various examples, the processor is configured to receive user-generated instructions (e.g., the target location and/or the target orientation).

In an embodiment, the processor is in communication with both the imaging element and power source. In another embodiment, the processor may also be in communication with data storage(s), and, optionally, display(s). The components of the system, such as the imaging element, power supply, sensors, computing device(s), processor(s), feedback controller(s), data storage(s), and/or display(s), and any other components of system, device or computing device, may communicate using any electronic wired or wireless means or protocols for communication known in the art, including but not limited to Ethernet™ Bluetooth™, WiFi™, infrared, near-field communications (NFC), radio-frequency identification (RFID), WiMAX™ (fixed or mobile), cellular communications protocols such as GSM, EDGE, GPRS, CDMA, EMTS, LTE, LTE-A, IMS, and any other cellular communications protocols including, but not limited to, up to and including 5G protocols as established under the 3 GPP, for example, and any other communications protocols suitable for the method(s) and system(s) described herein, including any proprietary protocols. Components of the system may exist on the same network or on separate networks, and the network(s) may include any type of network suitable for the system(s) and method(s) described herein, including but not limited to wired or wireless personal area networks (PANs), local area networks (LANs), mesh or ad hoc networks, wide area networks (WANs), metropolitan area networks (MANs), virtual private networks (VPNs), and any other suitable network type, as well as any suitable network configuration or topology (e.g., token ring, star, bus, mesh, tree, etc.). The presently described system(s) further includes any components necessary to affect the communication and/or network type employed, such as wireless or wired routers and access points.

The presently described methods and systems may be implemented on a secure network to which access may be limited to authorized users by any known means and which may be protected by known security measures, such as by the use of firewalls. In some embodiments, authentication may be required before granting access to authorized users, such as where autologous cell manufacturing and/or patient data is involved and/or where compliance with government regulations is mandated (such as Title 21 of the U.S. Code of Federal Regulations). Such authentication may be implemented for any one or more of the system components, such as for access to a computing device or machine housing the processor, access to data storage, access to a database of the data storage, access to any of the sensors or sensor readings of the device or imaging element, access to a graphical user interface (GUI) of the system, access to the device or imaging element, etc. Security of the presently described methods and systems may be further provided for by encrypting communications among system components by any means or protocols known to persons skilled in the art, such as Internet Protocol Security (IPSec), Transport Layer Security (TLS), Secure Sockets Layer (SSL), etc., in order to reduce the potential for the tampering with or corruption of the preprogrammed correlative algorithm(s).

The presently described system may also include data storage for storing information associated with the described methods. The data storage may include, for example, various types of local or remote memory devices such as a hard disk or hard drive (of any type, including electromechanical magnetic disks and solid-state disks), a memory chip, including, e.g., random-access memory (RAM) and/or read-only memory (ROM), flash memory, optical memory such as CD(s) and DVD(s), floppy disks, and any other form of optical, physical, electronic, and/or magnetic memory devices in or on which information may be stored. The data storage may comprise non-volatile memory. In some embodiments, the data storage may only be accessed via secure data transfer, which may be accomplished using one or more known server platforms and security protocols. The information to be stored in the data storage may comprise, for example, one or more predetermined algorithms for correlating sensor inputs to various outputs and records of such predicted determinations along with associated actions (such as feedings) and/or associated timestamps, unique identifiers, authorized users and associated authentication information for use in authenticating users for authorized access to the data storage or any other system component, and any other pertinent information. In operation, the data storage is in communication with the processor.

The system may also include a display (which may be co-located with the processor, e.g., where the processor and display are part of a computer or server used for carrying out the method steps described herein) for visually presenting information associated with the described methods. The display may comprise, for example, a computer monitor (e.g., LCD, a CRT monitor, a projection (e.g., heads-up display (HUD) laser), etc. In some embodiments, the visual display may comprise, for example, that of a mobile device such as a tablet computer, cellular phone, smartphone, personal digital assistant (PDA), personal computer (PC), laptop computer, augmented reality display (e.g., Google™ Glass™ or Microsoft™ HoloLens™), etc. The information presented on the display may include any other information collected in the course of carrying out the methods described herein, prompts for information entry associated with one or more steps of the described methods, and/or any predetermined formulae or algorithms, as previously described. The display may also be capable of receiving input (such as, e.g., where the display includes a touch-screen and is capable of receiving touch input and accordingly transmitting information to the processor).

As used herein, the term “imaging device” generally refers to a device or a combination of a plurality of devices configured for capturing electronic images of the anisotropic particle within the device. As further used herein, the term “imaging” generally refers to continuously or subsequently one or more of detecting, mapping, recording, taking an image of at least one partial region within the device. The imaging element can comprise one or more sensors, in particular at least one optical sensor. The sensor may be formed as a unitary, single device or as a combination of several devices. A person of ordinary skill in the art can readily choose a suitable imaging element depending on the intended application. However, non-limiting examples of imaging elements include cameras, plate readers, or camera-mounted microscope systems (e.g., a scanning electron microscope (SEM)). In some examples, the imaging element can use visible light, fluorescent light, IR light, and/or UV light to detect the position of the anisotropic particle within the device. In some examples, the imaging element captures images at a rate of at least 10 frames per second (fps), such as at least 20 fps, at least 30 fps, at least 40 fps, at least 50 fps, at least 60 fps, at least 70 fps, at least 80 fps, at least 90 fps, at least 100 fps, at least 150 fps, at least 200 fps, at least 500 fps, or at least 1000 fps. In various examples, the imaging element provides a magnification of at least 50× (e.g., at least 100×, at least 200×, at least 300×, at least 400×, at least 500×, or at least 1000×).

The system 100 shown in FIGS. 1A and 1B further includes a power source 164 which controllably manipulates the respective power output 168 (168a, 168b, 168c) in each of the first 142, second 144, and third pairs 146 of electrodes. The power source can be used to direct electrical energy to each of the electrodes in the system. In various examples, the power source comprises a battery. In some examples, the system further comprises a light emitting device (e.g., a laser).

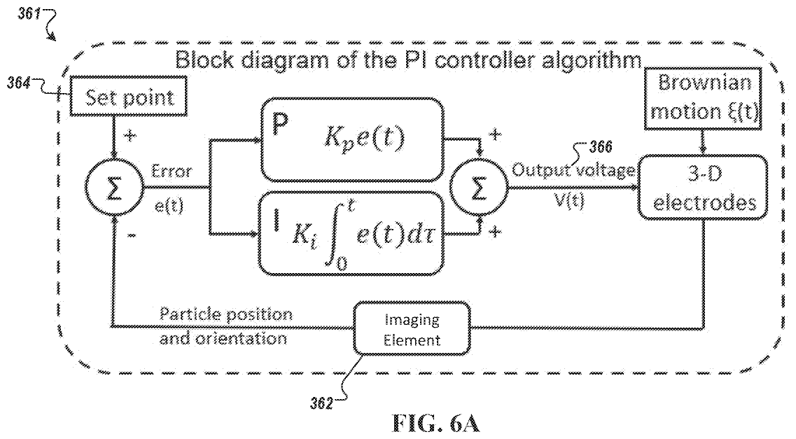

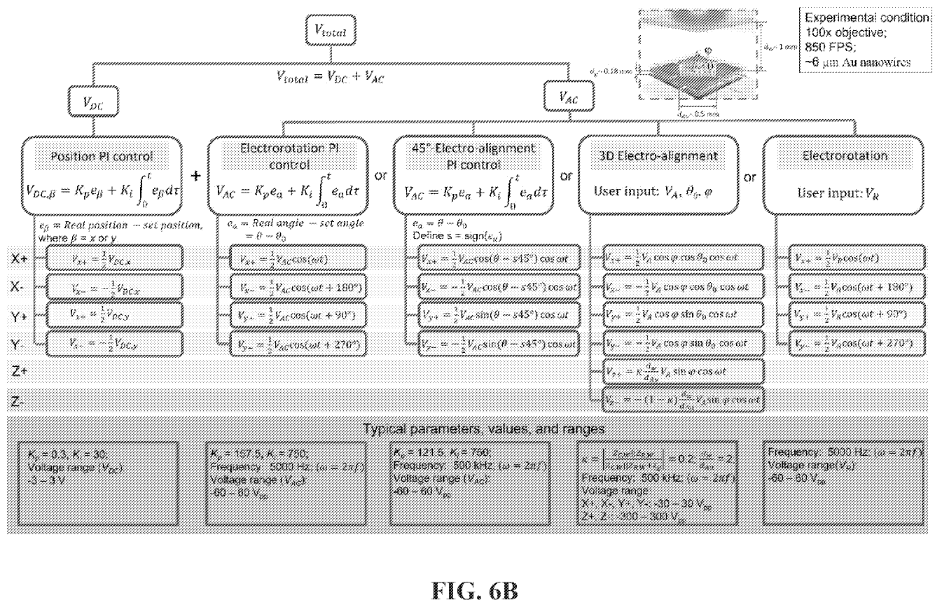

FIG. 6A depicts an example feedback control algorithm 361 that can be implemented on the processor using the real-time images collected by the imaging element 362. The feedback control algorithm 361 compares the real position/angle and set position/angle for each video frame captured by the imaging element 362 and calculates the deviation (real value−set value=deviation) from a set point 364. A feedback voltage 366 is applied based on the deviation in the form of a superimposed DC and AC voltage. The control is based on the proportional-integral (PI) algorithm, using a proportional term 372 and an integral term 374. Here, the integral term 374 is included to eliminate any steady-state errors. In various examples, the coefficients for the proportional term (Kₚ) and the integral term (Kᵢ) can be optimized (e.g., with the Ziegler-Nichols method). FIG. 6B shows a calculation of voltage signals for manipulating the anisotropic particle in different control modes.

The signal received from the imaging element can be received by the processor where the relative position of the particle can be extracted in real-time, for example, using a C++ computer program based on the OpenCV computer vision library and Qt.

In one example, a Gaussian filter is first applied to reduce the noise of the image. followed by a threshold filter to convert the grayscale image to a binary image. Next, the OpenCV function “cv::findContours” is called to retrieve the contour of the anisotropic particle. Finally, another OpenCV function “cv::minAreaRect” is used to find a rectangle with minimum area that bounds the contour of the anisotropic particle. From the rectangle, both the position and in-plane angle of the particle can be determined. When an anisotropic particle (e.g., a nanowire) is vertically oriented by an electro-alignment torque, a square (symmetric rectangle) can still correctly identify its position from the projected image, where the angle, vertical to the substrate, is controlled by a vertical E-field, driven by the minimization of the net electric torque; In this case, there is no image-feedback control for reaching this angle. If an anisotropic particle (e.g., a nanowire) is tilted, a rectangle contour can readily identify its position. A direct electro-alignment is used to align a wire in 3D, therefore, the voltages applied to the Z and in-plane directions define the tilt angle, not via imaging analysis; the angle calculated from an image is only used to verify the obtained angle.

Various control algorithms can be used in the present system, including a proportional-integral-derivative (PID) controller or the proportional-integral (PI) control algorithm shown in FIG. 6A. In various embodiments, a PID controller is used. The PID control algorithm can be used to calculate the feedback electric voltages which can translocate the particles to designated positions and orientations. Receiving the electric signals from the C++ program, the customized function generator can generate the corresponding voltages in each of the electrodes. The translation of an anisotropic particle in the XY-plane can be realized by the electrokinetic forces created via Direct Current (DC) voltages while the 3-D orientation of the anisotropic particle can be realized by electro-orientation with Alternating Current (AC) voltages. By superimposing the DC and AC voltages, the system can control both the position and orientation of a particle simultaneously. In some examples adopting a feedback controller, such as a PID feedback control algorithm, the random movement of a nanoparticle due to Brownian motion in a liquid medium can be effectively cancelled. As a result, the anisotropic particle's position and orientation can be contained to set points with ultrahigh precision. In various examples, the precision of the anisotropic particle is held up to tens of nanometers positioning and within a 0.5° orientation. Further description of the voltage control is included in U.S. Provisional Patent Application No. 63/498,247, which is incorporated by reference in its entirety.

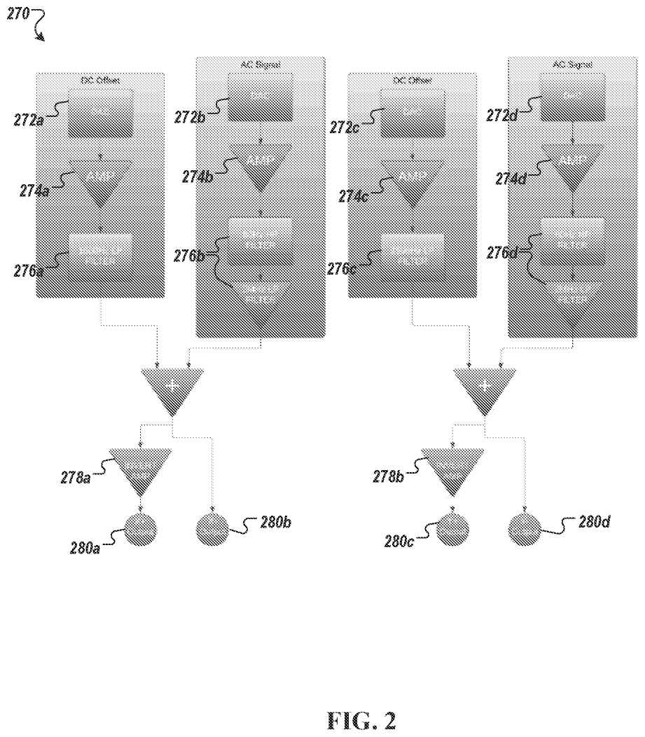

Modulation of the power to the electrodes can be achieved using a function generator, such as the one illustrated in FIG. 2. The function generator 270 includes four DACs (Digital-Analog Converters) (272a, 272b, 272c, 272d) that convert computer program generated digital electric signals from the processor into analog electric voltages. The analog electric voltages are then amplified (274a, 274b, 274c, 274d), filtered (276a, 276b, 276c, 276d), and inverted (278a, 278b), providing four output electric voltages (280a, 280b, 280c, 280d) for the manipulation in both X and Y directions.

### Methods

Also disclosed herein are methods for controlling a position and/or 3D orientation of an anisotropic particle in real time. In some examples, the methods can include: determining positional and angular information of an anisotropic particle within the device disclosed above using an imaging element; and adjusting a voltage in each of the first, second, and third pairs of electrodes of the device based on the positional information of the anisotropic particle in order to induce or suppress motion of the anisotropic particle. When a nanoparticle is dispersed in a suspension, its position and orientation will typically be agitated by Brownian motion and its diffusivity increases dramatically with the size reduction. As a result, there is a deleterious effect caused by the random motion, which hinders the high-precision manipulation of nanoparticles as bioprobes. For some anisotropic particles, the diffusivities can be characterized by two diffusion coefficients, Dₐ and D_{b} along its long axis (a) and short axis (b). D_{b} is smaller than Dₐ due to a greater drag force along the short axis and monotonically decreases with the increase of the length of the anisotropic particle. As a result, the control precision is greater along the short axis (b) than that along the long axis(a) and is proportional to the length of the anisotropic particle. When the geometrically anisotropic particle is aligned vertically, its in-plane Brownian motion, which is along the short axis (b), is suppressed by its long dimension. Thus, using the present method, the anisotropic particle can scan a substrate with interesting objects or features with its tip with a much higher control precision compared to that of a sphere with the same feature size.

The above method can be used, for example, for controllably delivering a therapeutic agent to a cell. In various examples, an anisotropic particle is controllably moved to a position proximate to a cell of a subject according to the above method. The anisotropic particle is further operatively linked to a moiety comprising a therapeutic agent. Thus, upon directing the particle to a position proximate to a cell (e.g., in contact with the cell), the therapeutical agent can be released using any method known in the art.

In some examples, the above method is used for forming a nanofabricated structure. In various embodiments, the methods include: controllably moving each of a plurality of anisotropic nanoparticles to a desired position on a substrate according to the above-described method. Each of the plurality of anisotropic particles can then be affixed to the substrate and/or together to form a nanostructure. The anisotropic particles can be affixed (i.e., partially or fully immobilized) using any means known in the art, such as through click chemistry. FIG. 5 shows one example of the method used to affix ten anisotropic particles to a fixed array of building blocks. However, the method can similarly be used to form more complex structures depending on the specific application.

Additionally disclosed herein are methods for diagnosing a condition in a subject. These methods can include, for example, contacting an anisotropic particle with a biological sample obtained from the subject; determining positional information of the anisotropic particle within the devices disclosed herewith using an imaging element; adjusting a voltage in each of the first, second, and third pairs of electrodes of the device based on the positional information of the anisotropic particle in order to induce or suppress motion of the anisotropic particle; and determining, based on one or more detected properties, a diagnosis for the condition. The term “biological sample,” as used herein, refers to a sample obtained from or within a biological subject, including samples of biological tissue or fluid origin obtained in vivo or in vitro. Such samples can be, but are not limited to, bodily fluid, organs, tissues (e.g., including resected tissue), fractions and cells isolated from mammals including, humans. Biological samples also may include sections of the biological sample including tissues (e.g., sectional portions of an organ or tissue). The term “biological sample” also includes lysates, homogenates, and extracts of biological samples.

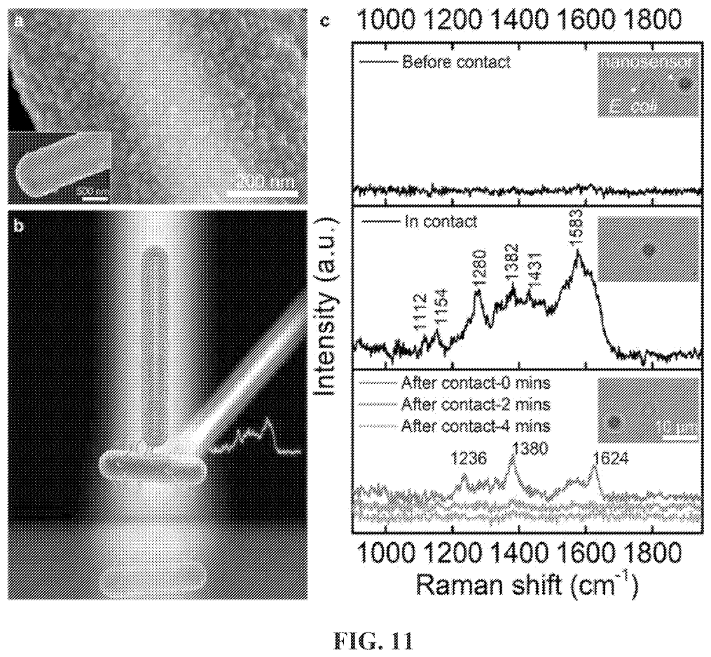

Also described herein are methods for detecting the presence of an analyte. Various embodiments include: determining, using an imaging element, positional and angular information of an anisotropic particle comprising a nanopatterned surface within one of the devices described above; adjusting a voltage in each of the first, second, and third pairs of electrodes of the device based on the positional information of the anisotropic particle to move the anisotropic particle to a target position within the device; irradiating the anisotropic particle with a source of radiation to produce a surface enhanced Raman spectroscopy (SERS) signal; determining, based on the SERS signal, whether an analyte is present at the target position. In further embodiments, the SERS-active anisotropic particle can comprise metal nanoparticles. In specific embodiments, the metal comprises a metal selected from the group consisting of Ru, Rh, Pd, Os, Ir, Pt, Au, Ag, Cu, Al, and combinations thereof. For example, FIG. 11 shows an Au@SiO₂ anisotropic particle coated with dense Ag plasmonic particles. The fabrication of the anisotropic particle can be accomplished by any technique known in the art, such as those techniques described in Xu et al. (2012), which is incorporated by reference in its entirety. The precise manipulation of a SERS-active anisotropic particle can provide analytical information about metabolic activity for a microbe of interest. For example, Ziegler et al. (2016), which is hereby incorporated by reference in its entirety, used SERS to characterize the metabolic profile of several strains of bacterial cells.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1: Precise Electrokinetic Position and 3D Orientation Control of a Nanowire Bioprobe in Solution

The present experiment utilized a manipulation system having a set of electrodes made on three layers, i.e., an Indium-Tin-Oxide (ITO) glass and in-plane Au quadruple microelectrodes separated by a PDMS well in the Z direction with another ITO layer deposited at the opposite side of the in-plane microelectrodes. Nanoparticles in suspension were confined in the PDMS well and subjected to electric fields. DC voltages cause transport via electroosmosis/electrophoresis, which is described by the Helmholtz-Smoluchowski equation under the assumption of a thin double layer (Masliyah, 2006), given by

$$u = - \frac{{ϵζ}_{s} E}{η}$$

and

$$U = \frac{{ϵζ}_{p} E}{η} ,$$

respectively, where u is the velocity of the electroosmotic flow, U is the velocity of the particle, ε is the permittivity of the medium, ζₛ and ζₚ are the zeta potential of the substrate and particle, η is the viscosity of the medium, and E is the electric field strength.

Electrorotation (τ_{R}), expressed as

$${τ}_{R} = - \frac{{E}^{2}}{2} Im [ {α}_{a} + {α}_{b} ] ,$$

was achieved by applying AC voltages with 900 sequential phase shift that rotate particles, where aₐ and a_{b} are the complex polarizabilities along the long axis a and short axis b of the particle, respectively; both the Maxwell-Wagner interfacial polarization and the presence of electric double layer can contribute to the complex polarizabilities. As an asynchronous effect, electrorotation supports high-speed spinning and rapid orientation. Kim, 2014.

Electro-alignment (τ_{A}) can be obtained owing to torques generated due to the interactions between the high-frequency AC electric fields and a polarized particle as calculated by

$${τ}_{A} = \frac{{E}^{2}}{2} Re [ {α}_{a} - {α}_{b} ] cos θsinθ ,$$

where θ is the angle between the electric field and the particle's long axis. In-plane alignment of a nanowire can be readily achieved by applying a simple AC electric field in a desired X-Y direction. However, the controlled alignment of nanowires along any desirable angle in 3D space, which is advantageous for nanowire probes, has not yet been realized with electric manipulation. One reason for this is because the orientation in space also requires control of the vertical electric field that passes through two dielectric media, which alters the electric-field distribution in the Z direction. Here, the study applied an equivalent circuit that accounts for the different dielectric layers with a virtual ground voltage set at the nanomanipulation plane to accurately compute the correct voltages on the Z-electrodes. Although a simple AC field in the Z direction can align nanowires vertically, this alignment is affected by the in-plane electrodes in all regions but the very center of the trap. Thus, such a simple design cannot be used to orient a nanowire in 3D. The fields can thus be applied either simultaneously or sequentially to achieve the respective transport, 3-D alignment, rotation, and their combinations.

According to Earnshaw's theorem, it is not possible to achieve a stable electric potential trap for a charged particle. It therefore becomes necessary to constantly counter the passive Brownian motion by inducing active motion, hence the term electrokinetic trap. The study therefore applied a vision-based voltage-feedback algorithm for simultaneously countering both the particle's translational and rotational Brownian motion. Specifically, the location and orientation of a particle obtained from a camera with imaging processing based on minimized rectangle contour were fed to a proportional-integral (PI) control algorithm. The requisite electric fields (voltages) were computed and applied to generate force and torque for anti-Brownian control with the same mechanisms for propulsion and rotation. Here, the PI control algorithm was optimized by tuning Kₚ and Kᵢ, the gains of the proportional and integral terms, respectively. For angle control, the P algorithm was also utilized. Both were optimized following the Ziegler-Nichols method.

### Precision Positioning

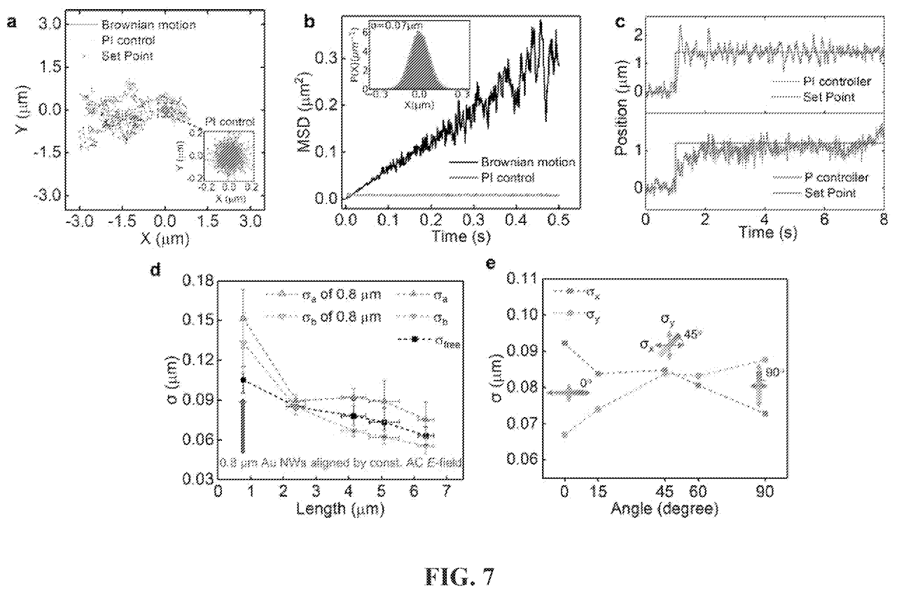

The experiment successfully achieved anti-Brownian-motion positioning of nanowires. As shown in FIG. 7, panels a-c, a nanowire was stably trapped at a designated target position (FIG. 2, panel c) with PI control. The random displacement from the target followed a Gaussian distribution (FIG. 7, panel b inset) with a precision (a) of 70 nm for a 4-μm long nanowire (170 nm in diameter) and the averaged position coinciding with the target. With further simultaneous orientation control, the precision in position reaches 56±6 nm for 6.4-μm-long nanowires aligned transversely. The precision increased with the length of the nanowire from 151±22 nm (length: 0.8 μm) to 75±13 nm (6.4 μm), and from 133±22 nm (0.8 μm) to 56±6 nm (6.4 μm) in parallel and transverse directions, respectively (FIG. 7, panel d). The observed increase of the control precision with length (L) can be understood from a particle's Brownian motion displacement given by

$$d = \sqrt{\frac{2 D}{f}}$$

in a frame of the camera recording (1/f), which determines the limit in precision of a feedback-controlled position. Here, D is the translational diffusion coefficient and f is the camera's operation frequency. For anisotropic cylindrical nanoparticles, Brownian motion can be described by the diffusion coefficients Dₐ and D_{b} (Boymelgreen, 2018; Fields, 2011):

$${D}_{a} = \frac{{k}_{B} T}{2 πη L} ( δ - {γ}_{a} ) , \qquad ( 1 )$$

$${D}_{b} = \frac{{k}_{B} T}{4 πη L} ( δ - {γ}_{b} ) , \qquad ( 2 )$$

along the long (a) and short (b) axes, respectively, where kB is the Boltzmann constant, T is Kelvin temperature, (δ−γₐ) and (δ−γ_{b}) are shape factors that depend only on the aspect ratio and

$$δ = ln ( \frac{2 L}{d} ) .$$

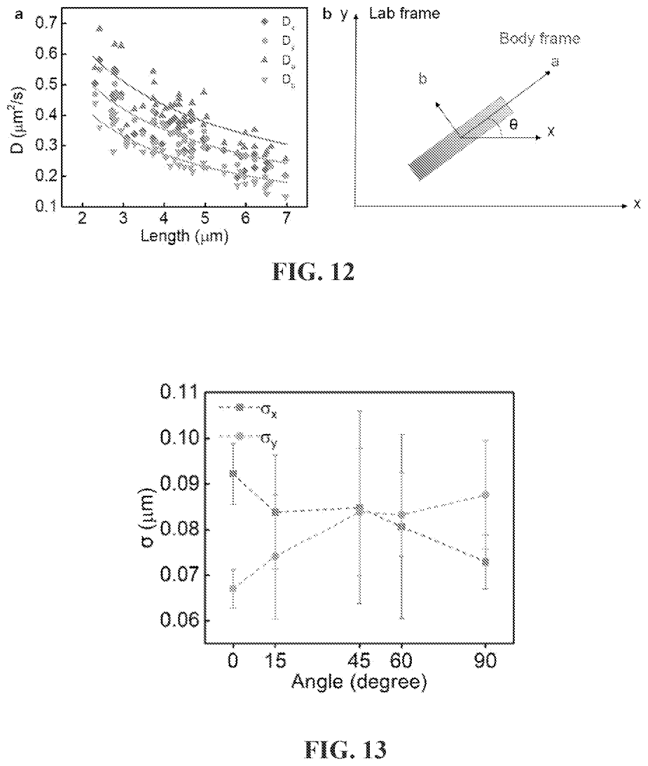

Dₐ is greater than D_{b} from the above equations, which is also seen in FIG. 12, panel a. Correspondingly, the positioning along the transverse direction is more accurate as it shows less Brownian motion, as D_{b}<Dₐ (FIG. 7, panel d). The orientation effect can be seen in FIG. 7, panel e, where the precision along the x axis ax steadily improves when a nanowire orients its long axis from parallel (0°) to transverse (90°) to the x axis, and vice versa for a_{y}.

It was observed that by reducing the length of a wire to 2 μm, the positioning becomes less angle dependent (FIG. 7, panel d). At this length, the out-of-plane motion of a nanowire increased significantly compared to that for a long nanowire, which makes the video-based feedback more difficult. The experiment overcame this by applying a linear AC E-field (50 Vₚₚ) when trapping a 0.8-μm nanowire. The precision still reaches 133±22 nm and 151±22 nm in the transverse and parallel orientations, respectively (FIG. 7, panel d). Indeed, in deionized water, the designed electric trap can successfully trap nanowires as small as 0.8 μm in length and simultaneously control their orientation. The precision in the position reaches 56±6 nm for transversely oriented nanowires (6.4 μm in length).

### Precision Angular Manipulation

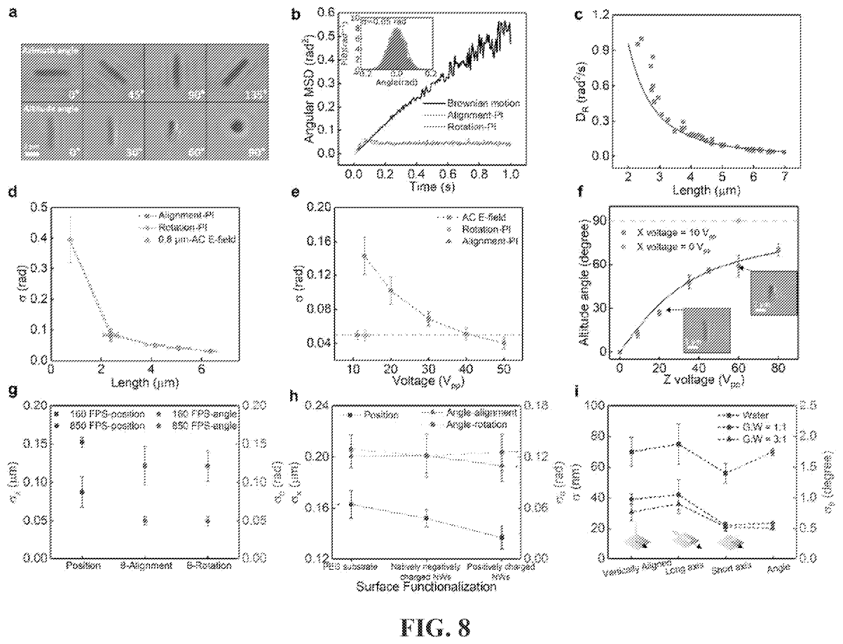

In-Plane Angular Control: A nanowire's rotational Brownian motion follows <Δθ²(t)>=2D_{R}t. (Han, 2006). The study employed a PI control based on either electrorotation or 45° electro-alignment, which successfully controlled the angular position (FIG. 8, panels a-b). Similar, to the manipulation of position, the histogram of angular displacement followed a Gaussian distribution with the standard deviation of the angular displacement denoted by σ and the averaged position coinciding with the target angle (inset of FIG. 8, panel b, electrorotation). Same as that of translational diffusivity, rotational diffusivity reduces for a longer nanowire following the Broersma relation (Broersma, 1960) (FIG. 8, panel c). The precision increased with the length and reached 1.75±0.060 and 1.78±0.13°, with electro-alignment-PI and electrorotation-PI algorithms for nanowires of 6.4 μm in length, respectively (FIG. 8, panel d).

While the application of a linear AC electric field can align a nanowire, the torque approaches zero as the target angle is approached. The rotation is thus correspondingly slow and liable to Brownian deviations. For instance, it takes 52 ms for a linear AC E-field at 40 Vₚₚ (500 kHz) to orient a rod (4 am in length and 170 nm in diameter) by 75°. While, the feedback-controlled electrorotation or electro-alignment field at only 10Vₚₚ just takes 25 ms and 38 ms, respectively. Feedback indeed makes for faster re-orientation and requires a much lower voltage (FIG. 8, panel e).

Out-of-Plane Angular Control is achieved with an AC field along the Z-direction. The angle can be set between 0 to 90° by tuning the ratio of the in-plane and vertical in-phase E-fields (FIG. 8, panel f). Experimentally, a series of altitude angles (φ) were obtained guided by theoretical predictions. This capability was utilized for high resolution tip-based pattern writing, bio-manipulation and sensing operations.

Working Area: The study examined the variation of the control precision of a 6-μm-long wire (170 nm in diameter) at 25 different locations in a 5×5 grid across an area of 117 m×117 μm, 62% the field-of-view of 40× objective (165 m×134 m). Here it was chosen to use 40× objective so that a larger area could be observed compared to that with 100× objective used above. The camera operated at 160 FPS. The result showed, across 25 locations, the control precision along the long direction of a wire (σ_{α}) is 127±6 nm and along the short axis (σ_{b}) is 100±3 nm. The angular control precision (σ_{θ}) was 3.7° 0.1°. The standard deviations of the precisions at the 25 locations were 6 nm, 3 nm, and 0.10 for σₐ, σ_{b}, and σ_{θ}, respectively.

The characterizations of positioning and angular precision in FIGS. 7 and 8 were statistically obtained by measuring 5-8 wires for each data point with the method of standard deviation. Owing to PI control, the averaged position/angle coincides with the targeted position/angle for the non-transporting wires. The positioning/angular precision for each individual nanowire is obtained from more than 6000 instantaneous position/angle data points collected during its trapping. The noise spectra for the PI and P control of the position and angle with electro-alignment and electrorotation reflect the oscillation nature of PI control, beneficial for the coincidence of the averaged position/angle with the targeted position/angle (insets of FIGS. 7, panel b and 8, panel b). Multiwire measurements exhibit greater errors compared to single wire measurement, which can be attributed to their dimensional variation. For single-wire control measurements, additional noise can arise from the instantaneous Brownian motion, changes in local environment, and finite observational times limited by the frame rate and pixel size. The imaging measurement method achieves the precisions as shown by statistical analysis.

### Strength of the Electrokinetic Trap

Both precisions in positioning and orientation can be improved by increasing the video-tracking frame rate (the study used up to 850 frames per second (FPS)) (FIG. 8, panel g), or by increasing the viscosity (FIG. 8, panel h). Interestingly, the particle's surface charge also influenced the precision of the in-plane manipulation. Native Au nanowires and a glass substrate are both negatively charged in deionized water. As a result, the propulsion forces due to electroosmosis and electrophoresis point in opposite directions. It is thus advantageous to modify the surface of the Au nanowires with positively charged polyelectrolytes [such as polydiallyldimethylammonium chloride/polystyrene sulfonate/aluminum chlorohydrate (PDDA/PSS/ACH trilayer)]. This charge reversal ensures that the electrophoretic and the electroosmotic force point in the same direction as that of the E-field. This enhances the propulsion force and thus boosts the average speed of the Au nanowires. For the experimental conditions it was determined that an increase in speed from 6.2 m/s to 15.2 m/s, coupled with an increase in the precision of positioning from 152±7 nm to 137±9 nm (FIG. 8, panel h). Similarly, the surface charge of the substrate affected the flow speeds. The PI-control performance was positively correlated with the restoring force of the trap; the higher the strength of the trap, the better the precision. However, surface treatment had minimal effect on the torques of electro-alignment or electrorotation, which are governed by the electric polarizability and the precision of angular manipulation was not strongly correlated with surface treatment.

The study determined the following spring constants of the trap (k), given by

$$k = \frac{{k}_{B} T}{{o}^{2}} ,$$

for the long (L) and short (S) directions of an in-plane nanowire, and along an in-plane direction for a vertically aligned nanowire (V) in glycerol water mixture (3:1) in FIG. 8, panel i as k_{L}=3.2×10⁻⁶ N/m, k_{S}=9.3×10⁻⁶ N/m, and k_{V}=4.3×10⁻⁶ N/m, as well as the corresponding precision in the spatial dimensions of 36±6 nm, 21±3 nm, and 31±5 nm, respectively. The nanowires can also be oriented with a high precision of 0.51±0.040 in plane with a corresponding torsional trap constant k_{R}=5.2×10⁻¹⁷ N·m/rad (all data in Table 1). Such high precision in both position and angle manipulation in water-based solution has not been achieved by other methods.

It was seen that the in-plane manipulation of a vertical nanowire was more precise than along the long axis of an in-plane nanowire (FIG. 8, panel i), which suggests that the fine tip of a rod-like particle can be used as a vertical “pen” for high spatial resolution probing, sensing, and operation.

### Size Effects of Nanoparticles

The study further evaluated the size effects of nanoparticles related to controlled positioning and orientation. The experiment directly compared a theoretical analysis and a corresponding experimental study. While the theoretical limit suggests that one can control a nanowire as small as 55 nm in length and 11 nm in diameter in water, regular optical imaging, however, does not attain such a resolution. Nevertheless, with a system based on an inverted optical microscope, a camera operating at 850 FPS, and a 100× objective, the study experimentally achieve the successful control of a 300-nm-long Au nanowire (125 nm in diameter) in a glycerol-water mixture in both position (DC-feedback voltage) and orientation (electro-alignment: 30 V, 500 kHz, 200-μm-gap electrode). The positioning precision reached 52±10 nm and 44±6 nm, along the long and short axes, respectively; the results were within a few times of the respective theoretical precision limits of 11 nm and 9 nm. The successful alignment is confirmed by the statistically smaller value of precision (higher precision) along the short axis compared to the precision along the long axis. For a comparison, the study also trapped the 300 nm nanowires without electro-alignment, and found that the control precisions along the two axes did not exhibit any significant statistical differences. The overall performance of the example 3D electrokinetic trap is summarized in below in Table 1.

TABLE 1
Summary of the achieved precision in the control of nanowires
for different experimental conditions. σₐ, σ_{b} are the
precisions along the long and short axis, respectively, σ_{ν},
and σ_{θ} are the precision when the wire is aligned
vertically and the angular precision, respectively. The orientation
control of the 300-nm-long nanowires was confirmed from the
directional anisotropic control precision.

| Length | | | | | |
|---|---|---|---|---|---|
| (μm) | Medium | σₐ(nm) | σ_{b}(nm) | σ_{ν}(nm) | σ_{θ}(°) |
| 6.4 | 3:1 | 36 ± 6 | 21 ± 3 | 31 ± 5 | 0.51 |
| | Glycerol:water | | (highest | | |
| | | | precision: | | |
| | | | 17) | | |
| 6.4 | DI water | 75 ± 13 | 56 ± 6 | 70 ± 9 | 1.75 |
| 0.8 | DI water | 151 ± 22 | 133 ± 22 | / | 22.7 |
| 0.3 | 3:1 | 52 ± 10 | 44 ± 6 | / | Confirmed |
| | Glycerol:water | | | | alignment |

### Active Propulsion Along Complex Trajectories

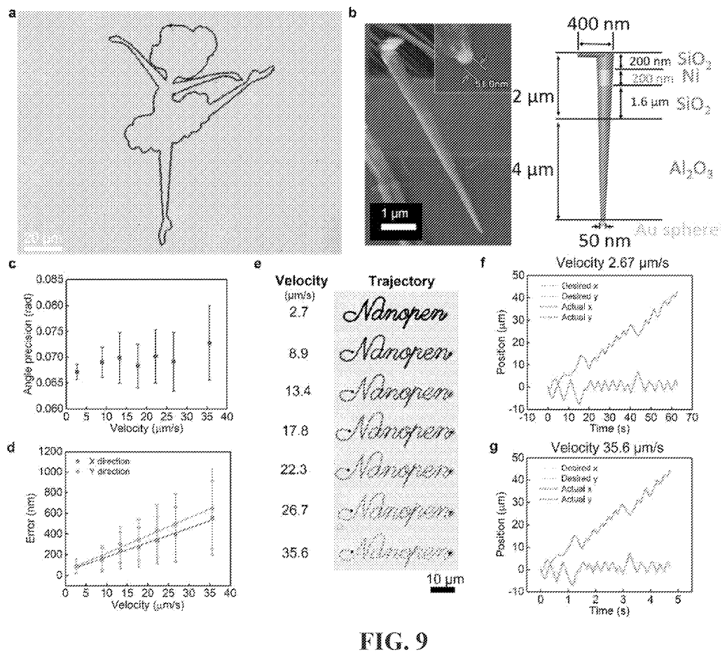

Examples of the combined effect of AC and DC electric fields on nanowires is shown in FIG. 9, panel a. Along the entire track, the nanoparticle was positioned with an accuracy of 136 nm (SD 110 nm) during transport, the orientation of the nanowire was controlled by aligning it transverse or parallel to the tangent of its trajectory, and by rotating it clockwise and counterclockwise at selected points along the trajectory. The orientation of the nanowire can be maintained at an arbitrary relative angle during the translation, such as at 45° and 135° to the transport direction. A second trajectory demonstrates in-plane (large cat in black) and out-of-plane control (small cat in blue), where the latter was achieved with a vertically aligned nanowire (FIG. 14).

The angular control was examined for a nanowire in active transport along a straight trajectory of 116 μm in length. Overall, the error in the tangent direction was greater than that in the transverse direction and both increased with transport speed. Due to the higher diffusion along the long axis of a nanowire, the nanowire's orientation also impacts the error. For instance, a nanowire aligned at 0° (long axis along the tangent direction) exhibited a larger error than that at 90° (short axis along the tangent direction). A similar dependence is also found for the manipulation precision. The experiment also determined the angular precision at different orientations as a function of the speed in FIG. 9, panel c. The standard distribution for a given condition was obtained from 6 measurements of the same wire. The result shows high precision in the angle control for all orientations and velocities (value range: 0.066 rad to 0.075 rad); there was a weak trend of a reduced angular precision and increased standard deviation as the speed of movement of the wire increased.

The electrokinetic trap can also be used to manipulate complex functional nanostructures such as a fabricated nanopen that is made of a 50-nm Au tip (diameter 50.9±23.4 nm) and an Al₂O₃/SiO₂ body shaft with integrated Ni magnet. The pen is shown in FIG. 9, panel c. The plasmonic Au tip can be heated with light and used to penetrate a cell. Maier, 2018. The Ni segment shown in FIG. 9, panel c permitted additional magnetic control and was used to ensure that the nanopen always stands up vertically with its Au tip pointing down (FIG. 9, panel e). Depending on the speed of movement, the nanopen was positioned with an accuracy of 90 nm (SD 68 nm) at 2.7 m/s and 650 nm (SD 390 nm) at 35.6 m/s, respectively (FIG. 9, panel d). The accuracy of the trace was, however, essentially unaffected (FIG. 9, panels f, g).

### Assembly of 3D-Oriented Nanoparticles

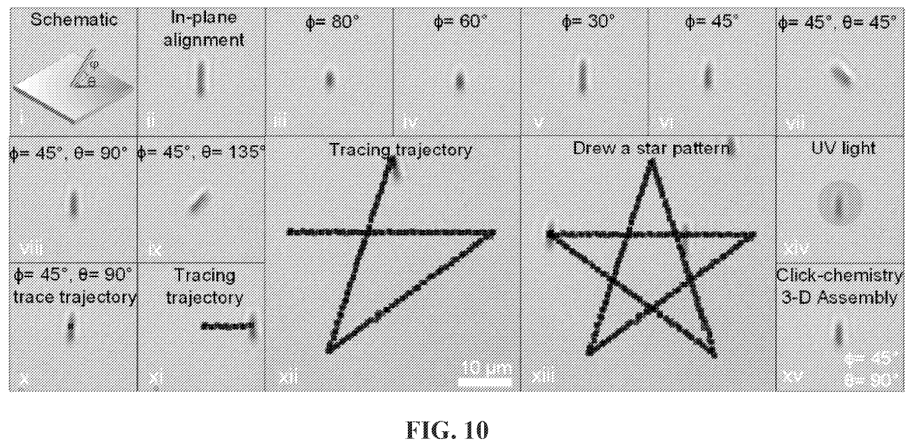

The present technique can also be used for the assembly of nanostructures with 3D orientation at chosen locations on a substrate, which is useful for electrical or optical applications. In FIG. 10, the experiment first moved a nanowire (Au) and oriented it in a series of programmed altitude angles with a fixed azimuth direction followed by rotating its azimuth angle at a given altitude angle. Next, the nanowire was moved rapidly along a star trajectory (45° in altitude and 90° in azimuth angle), before finally fixing it at a target position via a photochemical process to the substrate, maintaining its 3D orientation. The assembly is via UV-light-triggered click-chemistry between its tip and the substrate. With this approach, 50 Au segments encapsulated in silica are positioned in an array, demonstrating the applicability in 3D-oriented assembly of nanoparticles.

### Nanowire Probe Scanned Across a Single Bacterial Cell

Finally, the electrokinetic trap was used to move a nanowire probe across a bacterial cell while keeping it in position for spectral measurements. Its plasmonically-sensitive body enables the detection of metabolites released by a single bacterial cell. The surface-enhanced Raman scattering (SERS) sensor is a ~800-nm thick SiO₂-coated Au nanorod decorated with ~20 nm Ag nanoparticles (NPs). The Ag NPs provided plasmonic signal enhancement for Raman sensing (Xu, 2012; Xu, 2015); the diameter of the tip had approximately the width of an E. coli cell. The study operated the nanosensors in two modes, i.e., actively transport to an E. coli cell without any mechanical moving parts in the system; and by passive trapping the sensor with electric fields while mechanically moving a fixed E. coli to the sensor's tip. Both approaches allowed the contact of the tip of the plasmonic sensor with the bacterial cell. No Raman signals was be detected at a distance of 20 μm from an E. coli cell. However, upon contact a Raman spectrum is recorded. When the sensor moved 15 μm away from the E. coli, the Raman signal disappears in time (FIG. 11). The observation is consistent with the biochemical release from single live cell, which is known to be localized, within a few cell diameters. Fan, 2010. The Raman signals were seen to correspond to metabolites released from a single E-coli cell, and the spectra suggest that uric acid, xanthine, hypoxanthine, guanine, adenine, and adenosine monophosphate were detected. Premasiri, 2016. The E. coli cells were shown not to be affected by the electric fields. In this manipulation, the study set the imaging contrast that the translucent bacterial cells become invisible and the nanowire sensor with a metal core remains easily observable for the program's control. It was observed that when the nanosensor was close to a bacterial cell, its positional and orientational gently fluctuate within the trap, which can be attributed to a small variation of forces applied to the nanowire sensor induced by the presence and interaction with the bacterial cell, although imaging-wise, the bacterium is unobservable by the control program. The results suggest the electrokinetic-trap manipulated nanosensor can potentially function as an untethered biosensor with subcellular precision.

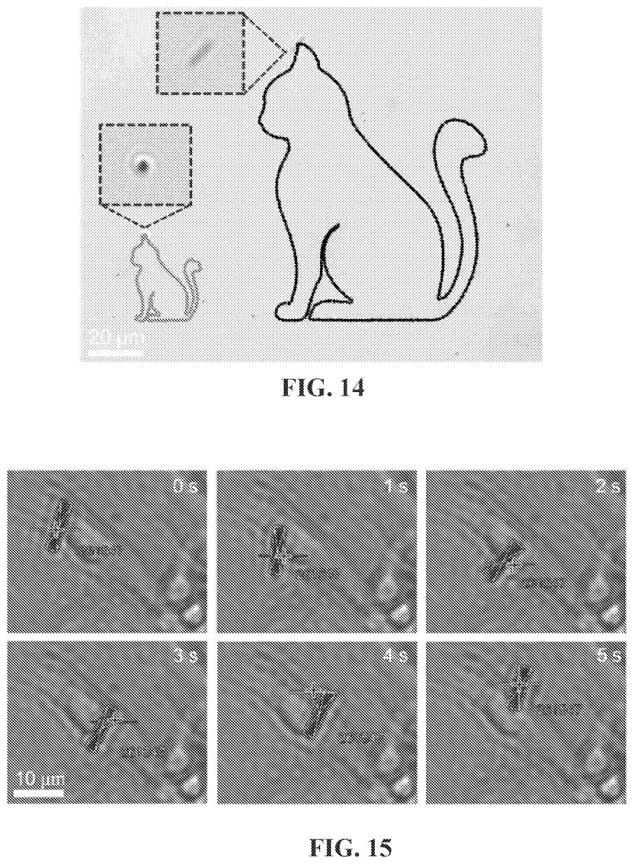

In summary, the example applications reported an electrokinetic trap that permits the simultaneous control of the 3D orientation and 2D position of anisotropic nanoparticles. It can be used to counter translational and rotational Brownian motion and at the same time actively steer and orient nanowires along complex trajectories. The system can easily operate in two modes, i.e., trapping of a particle, and active transport. This system provides for simultaneous control of 2D position and 3D orientation using an untethered nanowire with high temporal and with high positioning and orientation accuracy in such a versatile manner. The examples demonstrate positional control to within 21±3 nm and absolute angles of 0.51±0.040 in suspension, corresponding to a trap stiffness of 4.3×10⁻⁶ N/m and 5.2×10⁻¹⁷ N·m/rad, respectively. The system can operate close to the theoretically predicted precision due to Brownian fluctuations. For the experimental conditions (Camera: 850 FPS, deionized water), trapping of the nanowire was achieved in the transverse and parallel directions of 56 nm and 75 nm, and angle control to 1.8° for a wire with a diameter of 170 nm and a length of 6.4 μm. Moreover, the electrokinetic trap also achieved exceptional accuracy even during active transport of a particle in water, e.g., 90 nm at speeds of 2.7 m/s and 650 nm at speeds of 35.6 m/s, and controls a nanowire as small as 300-nm in length and 125 nm in diameter in both the position and its angle. The method can be used to manipulate nanowires, 50-nm-tipped nanopens, and silica encapsuled Au nanosensors in a number of applications, including those discussed above. The study successfully propelled free rods as vertically standing probes, and showed that it is possible to fully control a nanoprobe such that its plasmonic tip is moved in solution across the surface of a bacterial cell and stably positioned at a designated location on the bacterium for detection. The nanosensor thus provides a means to obtain location-specific SERS signals from metabolites released from a single E. coli cell. The electrokinetic trap can use a 3-D microelectrode arrangement and is suitable for on-chip and in-vitro applications. It works in ionic solutions (1 mM potassium chloride) and cell culture solution (FIG. 15).

The performance of the electrokinetic trap reported herein favorably compares to other techniques, and enables its use as an untethered tool for bio-spectroscopy. A clear difference to an anti-Brownian-motion positioning trap, for instance, is the achieved precision. The precision that was obtained for an untethered micron-sized wire with a 50 nm tip was higher than what can be obtained for a 50 nm spherical particle in an anti-Brownian trap. Orientation control has also not been shown previously to the level demonstrated in herein, with the highest precision reaching 0.5° for 6 m nanowires. When oriented in 3D with 2D positioning control, the nanoscale tip (50 nm) and micrometer-long-body provide nanoscale resolution together with an enhanced precision due to the micron-scale body that ensures that the Brownian motion is suppressed.

The electrokinetic trap can be used to assemble arrays of free nanostructures and to manipulate a nanoprobe in order to detect a bacterial cell's metabolites. However, the underlying principles can be generalized to use in other applications, such as micro/nanorobotics, assembly and micromanipulation, and biological measurements with subcellular resolution.

### Electrokinetic Trap and Experimental Procedure

The quadruple microelectrodes were fabricated by the standard photolithography by using photoresist MICROPOSIT S1811 (Kayaku Advanced Materials, Inc.) on the backside of ITO coated coverslips (22×22 mm, Thickness #1.5 (0.16 to 0.19 mm thick), 8-12 Ohms, Structure Probe, Inc.). A polydimethylsiloxane (PDMS) well with a diameter of 4 mm and a thickness of 1 mm was used to confine the nanoparticle suspension. Another ITO-coated coverslip was placed on top of the PDMS well with the ITO side in contact with the suspension. The entire chip was placed on an inverted microscope (IX71, Olympus) with a 100× oil immersion objective (NA=1.3). In the pattern tracking demonstration, a 50× objective (NA=0.80) was used; in the Raman sensing experiment, a 20× objective (NA=0.45) was employed; in the assembly experiment, a 40×UV objective (LMU-40X-UVB, NA=0.49, Thorlabs) was used.

In a typical experiment, 13 μL of the nanoparticle suspension in deionized water was dispersed in the PDMS well. The nanoparticles (e.g. Au nanowires, the multifunctional nanopens, and the SERS nanosensors) were well diluted such that particle-particle interactions were not observed.

A complementary metal-oxide-semiconductor (CMOS) camera (acA1300-200 um, Basler) with frame rate of 160 FPS and 850 FPS, for large area and high-speed imaging, respectively. A customized program based on OpenCV was developed to analyze the images and determine both the center of mass and orientation of a longitudinal nanoparticle by finding a rectangle with minimum area that bounds the contour of the nanowire followed by executing the PI control algorithm for electric manipulation. A customized function generator provides electric voltages to the chip. Two function generators (33250A, Agilent) and an amplifier (9200, Tabor Electronics) provide voltages in the Z-direction.

### PI Control Algorithm

The program compares the real position/angle and set position/angle for each video frame captured by the CMOS camera and calculates the deviation (real value−set value=deviation). A feedback voltage is applied based on the deviation in the form of a superimposed DC and AC voltage. Here, the DC voltage is used to correct the position deviation based on the combined electroosmotic and electrophoretic effects. The AC voltage orients a long nanostructure by electric torque, either through electro-alignment or electrorotation. For small nanoparticles with high diffusivities in the Z direction, the experiment used direct electro-alignment by applying a constant AC voltage along a chosen direction. The torque due to electrorotation is independent of the nanowires angle with respect to the field. While the torque due to electro-alignment was a function of the angle between a particle's long axis and E-field direction, it is maximal at 45°. To achieve the highest control efficiency, when employing the alignment field, the study applied it along a direction that is 45° from a nanowire's instantaneous angle until it rotated to the desired orientation. The control is based on the proportional-integral (PI) algorithm. Here, the integral term is included to eliminate any steady-state errors. The coefficients for the proportional term (Kₚ) and the integral term (K) were optimized with the Ziegler-Nichols method. The coefficients differed for different particles and experimental conditions.

### Fabrication

Fabrication of Au Nanowires. The Au nanowires were synthesized by electrodeposition into nanoporous templates (110605 Nuclepore™ Track-Etched Membranes, pore size 0.1 μm, polycarbonate, Whatman) in a three-electrode electrochemical cell. Specifically, the experiment deposited 500 nm Cu by electron-beam evaporation on the back side of a nanopore template, which served as the working electrode. A Pt wire, and a Ag/AgCl (3 M KCl) electrode served as the counter and reference electrode, respectively. A constant voltage of −0.9 V (v.s. Ag/AgCl) was applied to reduce Au ions in the electrolyte (434 HS RTU, Technic Inc.) to metallic Au in the nanopores. The length of the nanowires was controlled by the reaction time and the diameter was determined by the pore size. Etching the Cu film and dissolving the polycarbonate template with chloroform release the nanowires. Au nanowires were centrifuged and washed three times and stored in deionized water.

Fabrication of Nanocapsules. Multi-segmented (Au/Ni)₄ nanocapsules were fabricated by electrodeposition into an anodized aluminum oxide (AAO) template (Anodisc 47, Whatman) using the same three-electrode electrodeposition method discussed above, where Au is deposited at −0.9V, and Ni is deposited at −0.8 V (v.s. Ag/AgCl). The Au and Ni segments were 1.04±0.09 μm and 83±8 nm long, respectively. The average diameter is 296±47 nm. The nanowires were suspended in 0.8 mL deionized water, then, 3 mL ethanol (200 proof, Fisher Chemical), 200 μL tetraethyl orthosilicate (TEOS) (reagent grade, 98%, Sigma-Aldrich), and 50 μL ammonium hydroxide (NH₃·H₂O) (28-30% solution in water, Fisher Chemical) were mixed in the suspension. After one-hour of sonication, TEOS hydrolyzed and formed uniform silica shells on the nanowires' surface. After washing with deionized water and ethanol alternatively for 3 times, the Ni segments were etched with nitric acid (Fisher Chemical, diluted 3 times with deionized water before use) followed by washing and re-suspension in deionized water.

Fabrication of SERS-active Nanocapsule Sensors. The SERS-active nanocapsule sensors made of SiO₂-coated Au nanowires with surface-distributed Ag nanoparticles were fabricated following the procedure reported in Xu, 2012; Xu, 2015; Xu, 2013. Briefly, Au nanowires were fabricated by electrodeposition into an AAO template (pore size of 300 nm in diameter). Then, a SiO₂ layer is coated on each Au nanowire by TEOS hydrolysis under sonication. Finally, high-density Ag nanoparticles were synthesized on the silica surface by polyvinylpyrrolidone (PVP, MW 40,000, CAS #9003-39-B, Sigma-Aldrich) assisted Ag ions reduction, which provided hot spots for sensitive SERS detection.

Fabrication of Nanopens with 50 nm Au tips. The nanopens were fabricated by glancing angle deposition of SiO₂, Al₂O₃, and Ni on a packed monolayer of 50 nm Au particles covering a Si substrate. Au particles were prepared by block copolymer micelle nanolithography followed by electroless growth of Au. The block copolymer was dissolved in toluene at a concentration of 4 mg/mL, and HAuCl₄·3H₂O powder is added to yield self-assembled micelles loaded with HAuCl₄ in their cores. The micelles are then spin-coated as a uniform monolayer onto piranha cleaned silicon wafer. The wafer was then treated under W10 plasma (350 W, 0.4 mbar) for 45 min to remove the polymer and reduce the metal such that a regular quasi-hexagonal array of 10 nm Au particles formed. The substrate was subsequently immersed in an aqueous solution of 0.1% gold chloride trihydrate and 1 mM hydroxylamine hydrochloride for 30 s, followed by washing with deionized water and drying with nitrogen gas. This step enlarged the diameter of the AuNPs to 50 nm. Another plasma treatment removed the residual polymers. The wafer was transferred to the deposition setup for e-beam evaporation at a glancing angle of 85°. A 10 nm TiO₂ layer was first deposited on the Au particles as an adhesion layer, followed by 4 μm Al₂O₃, followed by 2 m SiO₂, 200 nm Ni, and finally 200 nm SiO₂. After the substrate is rotated by 180°, 400 nm of SiO₂ is deposited to allow the ends of the nanopen to be distinguished in an optical microscope. To increase electric polarizability for vertical alignment, the nanopens are dispersed on Si wafer and coated with 5 nm Cr and 10 nm Au by e-beam evaporation.

Surface Functionalization with Click Chemistry

The substrates (glass with quadruple electrodes) were immersed in 10 mg/mL trimethoxysilane-PEG alkyne (MW 10,000, Rapp Polymere) solution (95% v/v ethanol and 5% v/v deionized water) with 1% v/v NH₃·H₂O added as a reaction catalyst. After incubating overnight, rinsing with deionized water they are storer at 4° C. before use.

The silica surface of the multisegment Au capsules (Au@SiO₂) were functionalized following a previously reported procedure. (Walker, 2016). Briefly, the Au@SiO₂ nanocapsules (2×10⁷ in 50 μL) were first functionalized in (3-aminopropyl)triethoxysilane (≥98.0%, CAS #919-30-2, Sigma-Aldrich), aqueous ammonia, and ethanol mixture (volume ratio 10:1:90). After shaking overnight, the nanocapsules were washed with ethanol multiples times and dried in vacuum under 50° C. for 1 hour. Then 100 μL 20 mg/mL HS-PEG-COOH (MW 5,000, Rapp Polymere), 50 μL 20 mg/mL N,N′-dicyclohexylcarbodiimide (99%, Sigma-Aldrich), and 50 μL 12 mg/mL N-hydroxysuccinimide (98%, Sigma-Aldrich) were dissolved and reacted in dimethyl sulfoxide (anhydrous, Sigma-Aldrich) for 5 hours in a glovebox with nitrogen atmosphere. The mixture was added to the functionalized nanostructures and left to react overnight. The Au capsules were washed with deionized water multiple times and stored in deionized water at 4° C. for future experiments.

For the assembly with UV-trigged “click chemistry” a concentration of 2 mg/mL photoinitiator 2-hydroxy-4′-(2-hydroxyethoxy)-2-methylpropiophenone (98%, CAS #106797-53-9, Sigma-Aldrich) is added to the functionalized multisegment Au@SiO₂ suspension. UV light at 6 mW/cm² is directed through a beam-collimator (made of a convex lens (LA4464-UV, Thorlabs), a diaphragm (CP20S, Thorlabs), and a second convex lens (LA4538-UV, Thorlabs)) to the microscope objective (LMU-40X-UVB, NA=0.49, Thorlabs). The size of the light spot (~10 m) projected via the objective is set with the diaphragm. When a functionalized multisegment Au@SiO₂ has been moved into position and oriented with the electrokinetic trap, then the UV light is switched on for 10 seconds to initiate the click reaction that immobilizes the multisegment Au@SiO₂ to the substrate.

### Raman Measurements

Escherichia coli (K-12 strain, Living, Nutrient Broth, Catalog No. 155068, Carolina Biological Supply Company. E. coli cells were washed by repeated centrifugation and resuspension in deionized water. The Raman signals were detected with a Raman microscope (Spectrometer: Acton SP2500, Princeton Instruments) excited by a 532 nm laser at 360 μW after passing through a 20× objective. The exposure time was 1 second and 20 averages have been recorded.

### Example 2: Anti-Brownian Motion Trap as a Scanning Microscope

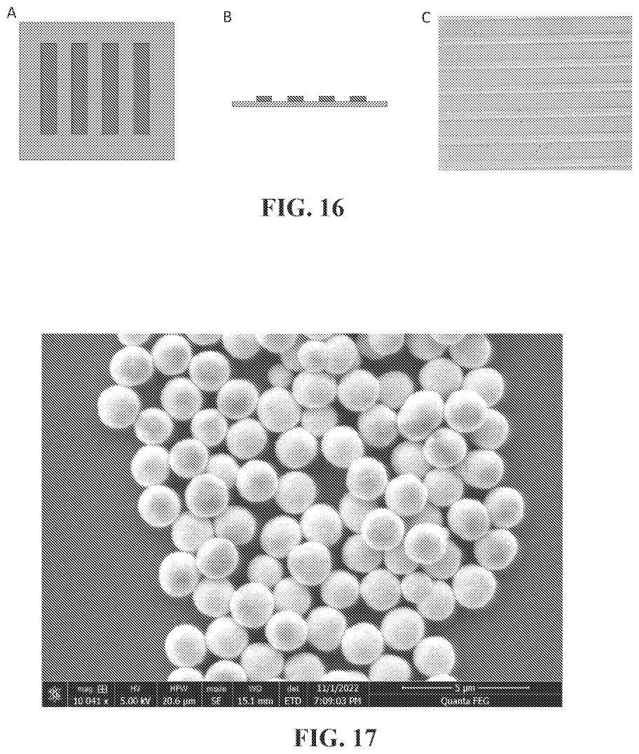

To study the applicability of the anti-Brownian motion system for determining topological data of a surface, an anisotropic particle was added to the system to contact to a patterned substrate. The substrate used in the present example was an S1811 substrate patterned with rectangular ridges by photolithography as shown in FIG. 16. The rectangular patterns etched on the substrate had a thickness of 1.1 μm and a width of 15 μm and were separated by a gap of 25 μm.

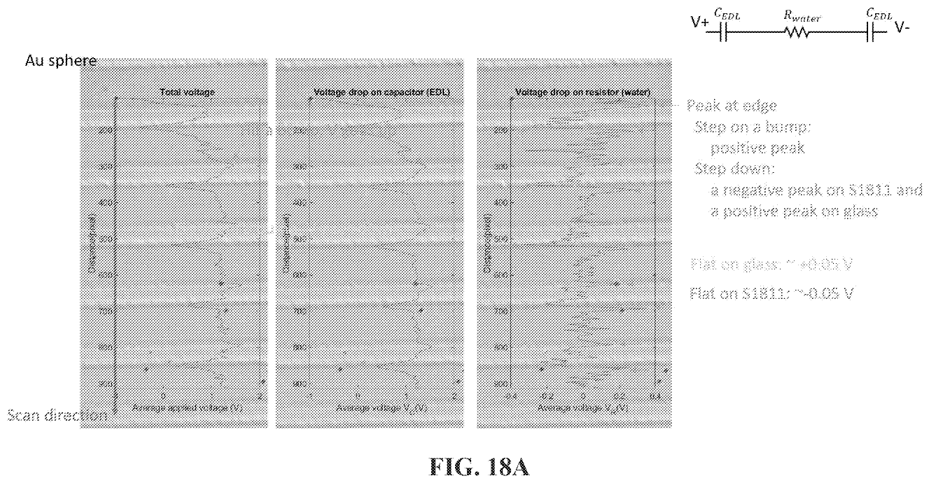

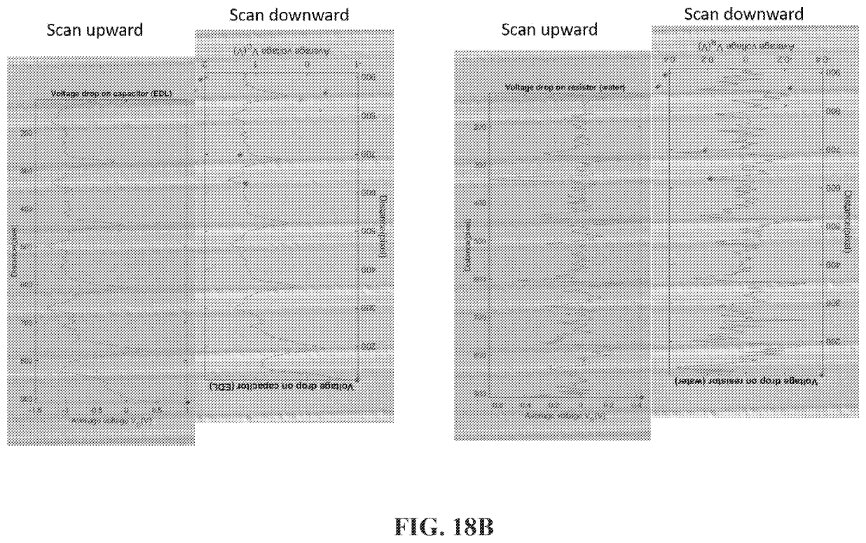

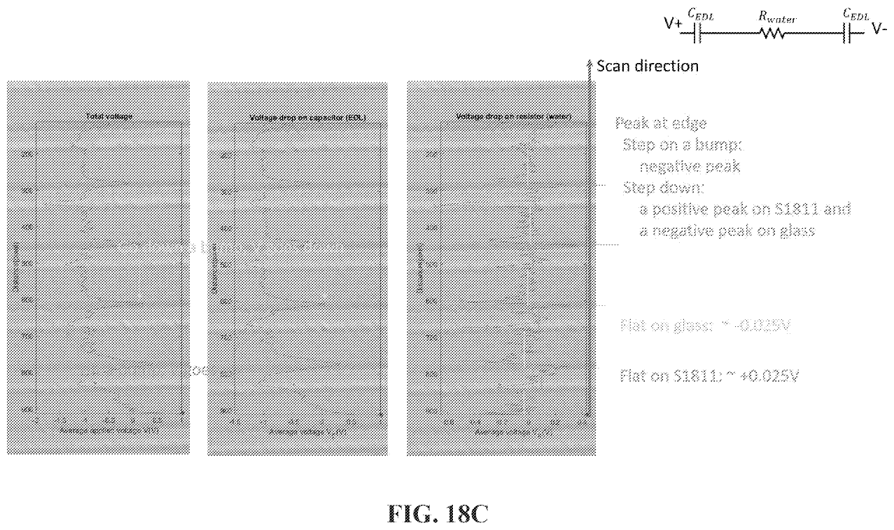

Gold nanospheres having an average diameter of 1.5 μm were used as the manipulated probe (FIG. 17). Using a similar procedure described above, the particle was controllably moved to various locations along the surface of the substrate for a predefined duration. At each position, the particle's position was recorded along with the applied voltage and current. As shown in FIGS. 18A-18C, the interaction between the substrate and the particle changes the dynamics of the particle, and this information was reflected in the recorded position, voltage, and current. By concurrently recording the positional information of the particle and the electrokinetic effect, the experiment was able to produce a graphical representation corresponding to the topology of the substrate.

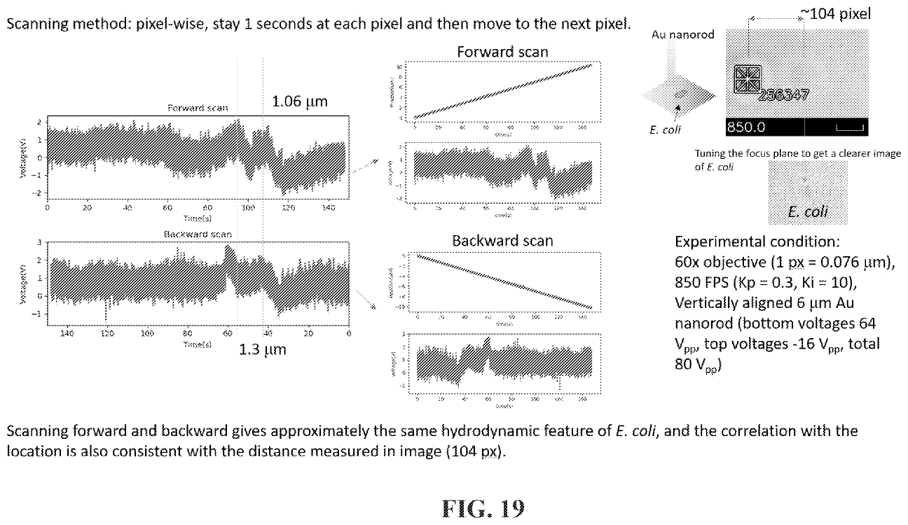

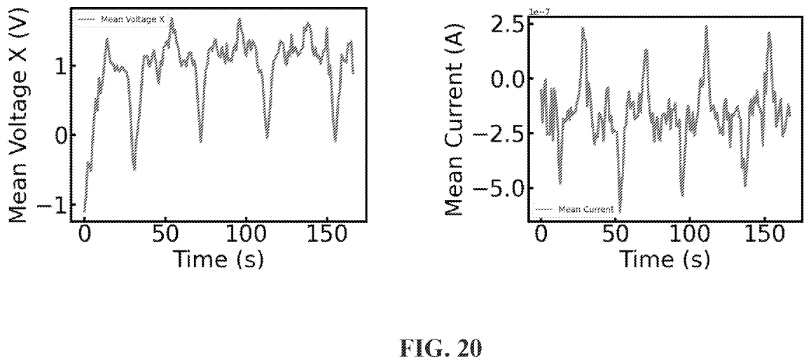

Next, a gold nanorod was used to scan an E. coli cell dried on the surface of a substate. The scanning procedure followed the experimental conditions described above. Briefly, a 60× objective (1 px=0.076 m), 850 FPS (Kp=0.3, Ki=10) camera were used to image the gold nanorod (6 μm). To orient the Au nanorod in a vertical alignment, an AC voltage was applied (bottom voltages 64 Vₚₚ, top voltages −16 Vₚₚ, total 80 Vₚₚ). The experiment collected both a forward and backward scan to validate the hydrodynamic features of the E. coli. The scan was performed in discrete pixels with a recording duration of 1 second at each pixel. Once the window of voltages and currents for a position was recorded, the system manipulated the movement of the particle to the next pixel and repeated the same data collection. Plots of the forward and backward scans are shown in FIG. 19. To reduce noise and improve readability, mean current and mean voltage can be used to map the topological features of the substrate. (FIG. 20).

The systems, methods, and devices of the appended claims are not limited in scope by the specific systems, methods, and devices described herein, which are intended as illustrations of a few aspects of the claims and any systems, methods, and devices that are functionally equivalent are intended to fall within the scope of the claims. Various modifications of the systems, methods, and devices in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. All references cited and discussed in this specification are incorporated herein by reference in their entirety and to the same extent as if each reference was individually incorporated by reference. The following patents, applications, and publications as listed below and throughout this document are hereby incorporated by reference in their entirety herein.

### REFERENCES

[1] Wang, W., Duan, W., Ahmed, S., Mallouk, T. E. & Sen, A. Small power: Autonomous nano- and micromotors propelled by self-generated gradients. Nano Today 8, 531-554 (2013). doi.org/10.1016/j.nantod.2013.08.009
[2] Palagi, S. & Fischer, P. Bioinspired microrobots. Nature Reviews Materials 3, 113-124 (2018). doi.org:10.1038/s41578-018-0016-9
[3] Li, J., Esteban-Fernández de Ávila, B., Gao, W., Zhang, L. & Wang, J. Micro/nanorobots for biomedicine: Delivery, surgery, sensing, and detoxification. Science Robotics 2, eaam6431 (2017). doi.org:doi:10.1126/scirobotics.aam6431
[4] Joh, H. & Fan, D. E. Materials and Schemes of Multimodal Reconfigurable Micro/Nanomachines and Robots: Review and Perspective. Advanced Materials 33, 2101965 (2021). doi.org/10.1002/adma.202101965
[5] Kim, K., Guo, J., Liang, Z. & Fan, D. Artificial Micro/Nanomachines for Bioapplications: Biochemical Delivery and Diagnostic Sensing. Advanced Functional Materials 28, 1705867 (2018). doi.org/10.1002/adfm.201705867
[6] Ru, C., Luo, J., Xie, S. & Sun, Y. A review of non-contact micro- and nano-printing technologies. Journal of Micromechanics and Microengineering 24, 053001 (2014). doi.org:10.1088/0960-1317/24/5/053001
[7] Dholakia, K., Drinkwater, B. W. & Ritsch-Marte, M. Comparing acoustic and optical forces for biomedical research. Nature Reviews Physics 2, 480-491 (2020). doi.org:10.1038/s42254-020-0215-3
[8] Liao, P. H., Tseng, C. Y., Ke, Z. Y., Hsieh, C. L. & Kong, K. V. Operando characterization of chemical reactions in single living cells using SERS. Chemical Communications 56, 4852-4855 (2020). doi.org:10.1039/DOCC01297A
[9] Zhao, X. et al. Surface-Enhanced Raman Scattering Optophysiology Nanofibers for the Detection of Heavy Metals in Single Breast Cancer Cells. ACS Sensors 6, 1649-1662 (2021). doi.org:10.1021/acssensors.1c00332
[10] Ashkin, A., Dziedzic, J. M., Bjorkholm, J. E. & Chu, S. Observation of a single-beam gradient force optical trap for dielectric particles. Optics Letters 11, 288-290 (1986). doi.org:10.1364/OL.11.000288
[11] Ghosh, S. & Ghosh, A. All optical dynamic nanomanipulation with active colloidal tweezers. Nature Communications 10 (2019). doi.org:10.1038/s41467-019-12217-2
[12] Higurashi, E., Sawada, R. & Ito, T. Optically induced angular alignment of trapped birefringent micro-objects by linearly polarized light. Physical Review E 59, 3676-3681 (1999). doi.org:10.1103/PhysRevE.59.3676
[13] Huang, Y. et al. Three-axis rapid steering of optically propelled micro/nanoparticles. Review of Scientific Instruments 80, 063107 (2009). doi.org:10.1063/1.3156838
[14] Bingelyte, V., Leach, J., Courtial, J. & Padgett, M. J. Optically controlled three-dimensional rotation of microscopic objects. Applied Physics Letters 82, 829-831 (2003). doi.org:10.1063/1.1544067
[15] Gosse, C. & Croquette, V. Magnetic tweezers: micromanipulation and force measurement at the molecular level. Biophysical journal 82, 3314-3329 (2002). doi.org:10.1016/S0006-3495(02)75672-5
[16] Ghosh, A. & Fischer, P. Controlled Propulsion of Artificial Magnetic Nanostructured Propellers. Nano Letters 9, 2243-2245 (2009). doi.org:10.1021/n1900186w
[17] Zhang, L. et al. Artificial bacterial flagella: Fabrication and magnetic control. Applied Physics Letters 94, 064107 (2009). doi.org:10.1063/1.3079655
[18] Kummer, M. P. et al. OctoMag: An Electromagnetic System for 5-DOF Wireless Micromanipulation. IEEE Transactions on Robotics 26, 1006-1017 (2010). doi.org:10.1109/TRO.2010.2073030
[19] Zhang, Z., Huang, Y. & Menq, C. H. Actively Controlled Manipulation of a Magnetic Microbead Using Quadrupole Magnetic Tweezers. IEEE Transactions on Robotics 26, 531-541 (2010). doi.org:10.1109/TRO.2010.2047526
[20] Ghosh, S. & Ghosh, A. Mobile nanotweezers for active colloidal manipulation. Science Robotics 3, eaaq0076 (2018). doi.org:doi:10.1126/scirobotics.aaq0076
[21] Tanyeri, M., Johnson-Chavarria, E. M. & Schroeder, C. M. Hydrodynamic trap for single particles and cells. Applied physics letters 96, 224101-224101 (2010). doi.org:10.1063/1.3431664
[22] Kumar, D., Shenoy, A., Li, S. & Schroeder, C. M. Orientation control and nonlinear trajectory tracking of colloidal particles using microfluidics. Physical Review Fluids 4, 114203 (2019). doi.org:10.1103/PhysRevFluids.4.114203
[23] Ropp, C. et al. Fabrication of Nanoassemblies Using Flow Control. Nano Letters 13, 3936-3941 (2013). doi.org:10.1021/n1402059u
[24] Mathai, P. P., Carmichael, P. T., Shapiro, B. A. & Liddle, J. A. Simultaneous positioning and orientation of single nano-wires using flow control. RSC Advances 3, 2677-2682 (2013). doi.org:10.1039/C2RA23190E
[25] Ding, X. et al. On-chip manipulation of single microparticles, cells, and organisms using surface acoustic waves. Proceedings of the National Academy of Sciences of the United States of America 109, 11105-11109 (2012). doi.org:10.1073/pnas.1209288109
[26] Cao, H. X. et al. Holographic Acoustic Tweezers for 5-DoF Manipulation of Nanocarrier Clusters toward Targeted Drug Delivery. Pharmaceutics 14, 1490 (2022).
[27] Braun, M. & Cichos, F. Optically Controlled Thermophoretic Trapping of Single Nano-Objects. ACS Nano 7, 11200-11208 (2013). doi.org:10.1021/nn404980k
[28] Chen, Y. et al. Carbon Helical Nanorobots Capable of Cell Membrane Penetration for Single Cell Targeted SERS Bio-Sensing and Photothermal Cancer Therapy. Advanced Functional Materials 32, 2200600 (2022). doi.org/10.1002/adfm.202200600
[29] Ando, J., Fujita, K., Smith, N. I. & Kawata, S. Dynamic SERS Imaging of Cellular Transport Pathways with Endocytosed Gold Nanoparticles. Nano Letters 11, 5344-5348 (2011). doi.org:10.1021/n1202877r
[30] Fennimore, A. M. et al. Rotational actuators based on carbon nanotubes. Nature 424, 408-410 (2003). doi.org:10.1038/nature01823
[31] Fan, D. L., Zhu, F. Q., Cammarata, R. C. & Chien, C. L. Manipulation of nanowires in suspension by ac electric fields. Applied Physics Letters 85, 4175-4177 (2004). doi.org:10.1063/1.1812364
[32] Chang, S. T., Paunov, V. N., Petsev, D. N. & Velev, O. D. Remotely powered self-propelling particles and micropumps based on miniature diodes. Nature Materials 6, 235-240 (2007). doi.org:10.1038/nmat1843
[33] Edwards, B., Engheta, N. & Evoy, S. Electric tweezers: Experimental study of positive dielectrophoresis-based positioning and orientation of a nanorod. Journal of Applied Physics 102, 024913 (2007). doi.org:10.1063/1.2753584
[34] Fan, D. L., Cammarata, R. C. & Chien, C. L. Precision transport and assembling of nanowires in suspension by electric fields. Applied Physics Letters 92, 093115 (2008). doi.org:10.1063/1.2891091
[35] Boymelgreen, A. M., Balli, T., Miloh, T. & Yossifon, G. Active colloids as mobile microelectrodes for unified label-free selective cargo transport. Nature Communications 9, 760 (2018). doi.org:10.1038/s41467-018-03086-2
[36] Fields Alexander, P. & Cohen Adam, E. Electrokinetic trapping at the one nanometer limit. Proceedings of the National Academy of Sciences 108, 8937-8942 (2011). doi.org:10.1073/pnas.1103554108
[37] Cohen, A. E. Control of Nanoparticles with Arbitrary Two-Dimensional Force Fields. Physical Review Letters 94, 118102 (2005). doi.org:10.1103/PhysRevLett.94.118102
[38] Galajda, P. & Ormos, P. Orientation of flat particles in optical tweezers by linearly polarized light. Optics Express 11, 446-451 (2003). doi.org:10.1364/OE.11.000446
[39] Sachs, J., Günther, J. P., Mark, A. G. & Fischer, P. Chiroptical spectroscopy of a freely diffusing single nanoparticle. Nature Communications 11, 4513 (2020). doi.org:10.1038/s41467-020-18166-5
[40] Broersma, S. Rotational Diffusion Constant of a Cylindrical Particle. The Journal of Chemical Physics 32, 1626-1631 (1960). doi.org:10.1063/1.1730994
[41] Jones, T. B. Electromechanics of Particles. (Cambridge University Press, 1995).
[42] Kim, K., Xu, X., Guo, J. & Fan, D. L. Ultrahigh-speed rotating nanoelectromechanical system devices assembled from nanoscale building blocks. Nature Communications 5, 3632 (2014). doi.org:10.1038/ncomms4632
[43] Masliyah, J. H. & Bhattacharjee, S. Electrokinetic and colloid transport phenomena. (John Wiley & Sons, 2006).
[44] Liang, Z. & Fan, D. Visible light-gated reconfigurable rotary actuation of electric nanomotors. Science Advances 4, eaau0981 (2018). doi. org:doi:10.1126/sciadv.aau0981
[45] Liang, Z., Teal, D. & Fan, D. Light programmable micro/nanomotors with optically tunable in-phase electric polarization. Nature Communications 10, 5275 (2019). doi.org:10.1038/s41467-019-13255-6
[46] Guo, J., Gallegos, J. J., Tom, A. R. & Fan, D. Electric-Field-Guided Precision Manipulation of Catalytic Nanomotors for Cargo Delivery and Powering Nanoelectromechanical Devices. ACS Nano 12, 1179-1187 (2018). doi.org:10.1021/acsnano.7b06824
[47] Earnshaw, S. On the Nature of Molecular Forces which Regulate the Constitution of Luminiferous Ether. Trans. Cambridge. Phil.Soc.PartI 7, 97/112 (1842).
[48] Han, Y. et al. Brownian Motion of an Ellipsoid. Science 314, 626-630 (2006).
[49] Walther, Andreas, and Axel H E Muller. “Janus particles: synthesis, self-assembly, physical properties, and applications.” Chemical reviews 113.7 (2013): 5194-5261.
[50] Maier, C. M. et al. Optical and Thermophoretic Control of Janus Nanopen Injection into Living Cells. Nano Letters 18, 7935-7941 (2018). doi.org:10.1021/acs.nanolett.8b03885
[51] Xu, X., Kim, K., Li, H. & Fan, D. L. Ordered Arrays of Raman Nanosensors for Ultrasensitive and Location Predictable Biochemical Detection. Advanced Materials 24, 5457-5463 (2012). doi.org/10.1002/adma.201201820
[52] Xu, X., Kim, K. & Fan, D. Tunable Release of Multiplex Biochemicals by Plasmonically Active Rotary Nanomotors. Angewandte Chemie International Edition 54, 2525-2529 (2015). doi.org/10.1002/anie.201410754
[53] Cooper, S. The constrained hoop: an explanation of the overshoot in cell length during a shift-up of Escherichia coli. Journal of bacteriology 171, 5239-5243 (1989).
[54] Fan, D. et al. Subcellular-resolution delivery of a cytokine through precisely manipulated nanowires. Nature Nanotechnology 5, 545-551 (2010). doi.org:10.1038/nnano.2010.104
[55] Premasiri, W. R. et al. The biochemical origins of the surface-enhanced Raman spectra of bacteria: a metabolomics profiling by SERS. Analytical and Bioanalytical Chemistry 408, 4631-4647 (2016). doi.org:10.1007/s00216-016-9540-x
[56] Xu, X. et al. Near-Field Enhanced Plasmonic-Magnetic Bifunctional Nanotubes for Single Cell Bioanalysis. Advanced Functional Materials 23, 4332-4338 (2013). doi.org/10.1002/adfm.201203822
[57] Walker, D., Singh, D. P. & Fischer, P. Capture of 2D Microparticle Arrays via a U V-Triggered Thiol-yne “Click” Reaction. Advanced Materials 28, 9846-9850 (2016). doi.org/10.1002/adma.201603586
[59] Chou, W. H. and Messing, R. O., 2007. Hypertensive encephalopathy and the blood-brain barrier: is δPKC a gatekeeper?. The Journal of clinical investigation, 118(1).
[60] Ziegler, J. G. & Nichols, N. B. Optimum settings for automatic controllers. trans. ASME 64 (1942). doi.org/10.1115/1.4019264
[61] Broersma, S. Viscous force and torque constants for a cylinder. The Journal of Chemical Physics 74, 6989-6990 (1981). doi.org:10.1063/1.441071
[62] Padding, J. T. & Briels, W. J. Translational and rotational friction on a colloidal rod near a wall. The Journal of Chemical Physics 132, 054511 (2010). doi.org:10.1063/1.3308649
[63] Li, J. et al. Nanomotor lithography. Nature Communications 5, 5026 (2014). doi.org:10.1038/ncomms6026
[64] Eichenlaub, S., Chan, C. & Beaudoin, S. P. Hamaker Constants in Integrated Circuit Metalization. Journal of Colloid and Interface Science 248, 389-397 (2002). doi.org/10.1006/jcis.2002.8241
[65] Lee, G. B., Lin, C. H., Lee, K. H. & Lin, Y. F. On the surface modification of microchannels for microcapillary electrophoresis chips. ELECTROPHORESIS 26, 4616-4624 (2005). doi.org/10.1002/elps.200500382
[66] Jones, T. B. Electromechanics of Particles. (Cambridge University Press, 1995).
[67] Akerlof, G. DIELECTRIC CONSTANTS OF SOME ORGANIC SOLVENT-WATER MIXTURES A T VARIOUS TEMPERATURES. Journal of the American Chemical Society 54, 4125-4139 (1932). doi.org:10.1021/ja01350a001
[68] U.S. Pat. No. 9,044,808 B2.
[69] U.S. Pat. No. 9,718,683 B2.
[70] U.S. Pat. No. 8,057,655 B1.\\

1. A device comprising:
a chamber defining a volume for containing a suspension comprising an anisotropic particle;
four co-planar electrodes disposed on an XY plane, wherein the four co-planar electrodes comprise a first pair of opposed and spaced apart electrodes, and a second pair of opposed and spaced apart electrodes orthogonally positioned relative to the first pair electrodes; and
a third pair of opposed and spaced apart upper and lower electrodes, wherein the third pair of electrodes form a space therebetween comprising the four co-planar electrodes and anisotropic particle;
wherein, in use, the anisotropic particle is electromagnetically coupled to each of the four co-planar electrodes and upper and lower electrodes.

2. The device of claim 1, wherein the first pair of electrodes is configured to controllably apply a voltage in an x-direction and the second pair of electrodes is configured to controllably apply a voltage in a y-direction, and the third pair of electrodes is configured to controllably apply a voltage in a z-direction.

3. (canceled)

4. The device of claim 1, wherein the first, second, and/or third pair of electrodes are configured to controllably apply both a DC voltage and an AC voltage.

5. The device of claim 1, wherein the first, second, and/or third pair of electrodes are disposed within the chamber.

6. The device of claim 1, wherein the first pair of electrodes and second pair of electrodes are separated by the same distance.

7. (canceled)

8. The device of claim 1, wherein the upper and/or lower electrodes comprise an optically transparent material.

9. The device of claim 8, wherein the optically transparent material comprises an indium tin oxide (ITO) or fluorine doped tin oxide (FTO) thin film.

10. The device of claim 1, wherein the four co-planar electrodes comprise non-reactive electrodes.

11. (canceled)

12. (canceled)

13. (canceled)

14. The device of claim 1, wherein the anisotropic particle is operatively linked to a moiety, wherein the moiety comprises a molecule, a protein, a peptide, DNA, RNA, a nucleic acid, a cell, a tissue, a virus, a nanoparticle, a metabolite, or a combination or derivative thereof.

15. (canceled)

16. (canceled)

17. (canceled)

18. The device of claim 1, wherein the anisotropic particle comprises a gold tip.

19. The device of claim 1, wherein the anisotropic particle comprises a nanopatterned surface.

20. The device of claim 19, wherein the nanopatterned surface comprises plasmonic nanoparticles.

21. (canceled)

22. The device of claim 1, further comprising a plurality of anisotropic particles.

23. (canceled)

24. (canceled)

25. (canceled)

26. (canceled)

27. A system comprising:
an imaging element positioned to interrogate a location of the anisotropic particle within the device according to claim 1;
a processor operatively connected to the imaging element and a power source electrically coupled to supply a power output to each of the first, second, and third pairs of electrodes, wherein the processor is configured to:
obtain a signal from the imaging element indicating a current position of the anisotropic particle relative to a target position;
determine a corrective voltage to apply to each of the first, second, and third pairs of electrodes from the signal and the target position; and
control the power source to modulate the power output to each of the first, second, and third pairs of electrodes to the corrective voltage.

28. (canceled)

29. (canceled)

30. (canceled)

31. (canceled)

32. A method for controlling a position and/or 3D orientation of an anisotropic particle in real-time, the method comprising:
determining positional information of an anisotropic particle within the device of claim 1 using an imaging element; and
adjusting a voltage in each of the first, second, and third pairs of electrodes of the device based on the positional information of the anisotropic particle in order to induce or suppress motion of the anisotropic particle.

33. A method of controllably delivering a therapeutic agent to a cell, the method comprising:
controllably moving an anisotropic particle to a position proximate to a cell of a subject according to the method of claim 32, wherein the anisotropic particle is operatively linked to a moiety comprising a therapeutic agent.

34. A method of forming a nanofabricated structure, the method comprising:
controllably moving each of a plurality of anisotropic nanoparticles to a desired position on a substrate according to the method of claim 32, and
affixing each of the plurality of anisotropic nanoparticles to the substrate and/or together to form a nanostructure.

35. A method for scanning a surface, the method comprising:
suppressing Brownian motion of the anisotropic particle according to the method of claim 32;
concurrently recording positional information of the anisotropic particle and a first feedback signal for a first pixel of the surface;
moving the anisotropic particle relative to the surface to a second pixel; and
concurrently recording positional information of the anisotropic particle and a second feedback signal for the second pixel of the surface.

36. (canceled)

37. (canceled)

38. A method of diagnosing a condition in a subject, the method comprising:
contacting an anisotropic particle with a biological sample obtained from the subject;
determining positional information of the anisotropic particle within the device of claim 1 using an imaging element;
adjusting a voltage in each of the first, second, and third pairs of electrodes of the device based on the positional information of the anisotropic particle in order to induce or suppress motion of the anisotropic particle; and
determining, based on one or more detected properties, a diagnosis for the condition.

39. A method for detecting the presence of an analyte, the method comprising:
determining, using an imaging element, positional information of an anisotropic particle comprising a nanopatterned surface within the device of claim 1;
adjusting a voltage in each of the first, second, and third pairs of electrodes of the device based on the positional information of the anisotropic particle to move the anisotropic particle to a target position within the device;
irradiating the anisotropic particle with a source of radiation to produce a surface enhanced Raman spectroscopy (SERS) signal;
determining, based on the SERS signal, whether an analyte is present at the target position.
